(19) United States
(12) Patent Application Publication
(10) Pub. No.: US 2024/0403107 A1
(43) Pub. Date: Dec. 5, 2024

(54) METHOD AND APPARATUS FOR SCHEDULING ACCESS TO MULTIPLE ACCELERATORS

(71) Applicant: Intel Corporation, Santa Clara, CA (US)

(72) Inventors: Ren WANG, Portland, OR (US); Yifan YUAN, Sunnyvale, CA (US)

(21) Appl. No.: 18/795,445

(22) Filed: Aug. 6, 2024

(51) Int. Cl. G06F 9/48

(52) U.S. Cl. CPC G06F 9/4818; G06F 9/4881

(57) ABSTRACT

Methods, apparatus, and computer programs are disclosed to schedule access to multiple accelerators. In one embodiment, a method is disclosed to perform: receiving a first request to process data for a first application by a first accelerator of a plurality of accelerators of a computing system, an accelerator of the plurality of accelerators being dedicated to one or more respective specialized computations of the computing system for data processing; scheduling resources for the first request based on the first request and a second request to process data for a second application by a second accelerator of the plurality of accelerators, the first and second requests having one or more priority indications indicating priority between the first and second requests; and processing the data for the first application using the resources as scheduled responsive to the first request.

### BACKGROUND ART

An accelerator is a specialized hardware component designed to perform specific tasks offloaded from a general-purpose CPU (Central Processing Unit) in a computing system. A computing system may include multiple accelerators each dedicated to one or more specific tasks. These accelerators can improve workload performance, reduce CPU cycles consumption and power consumption, as well as enhancing performance stability and predictability. Yet when an application uses multiple accelerators of a computing system, sequentially or in parallel, significant performance contention and inference may occur across different accelerators, leading to undesirable performance. Indeed, a computing system often supports multiple applications, which may use these accelerators simultaneously to process their respective specific tasks, and such usage without proper access scheduling among these accelerators for these applications exacerbates the issues further and causes unsatisfactory user experience.

### BRIEF DESCRIPTION OF THE DRAWINGS

The disclosure may best be understood by referring to the following description and accompanying drawings that are used to show embodiments of the disclosure.

FIG. 1 illustrates entities for scheduling access to multiple accelerators of a computing system per some embodiments.

FIG. 2 illustrates a request descriptor to request for an accelerator per some embodiments.

FIGS. 3A-3B illustrate the operations of scheduling for multiple accelerators per embodiments.

FIGS. 4A-4B illustrate a hybrid logical/physical view of a disaggregated parallel processor to schedule access to multiple accelerators per some embodiments.

FIG. 5 illustrates a flow diagram for operations to schedule access to multiple accelerators per some embodiments.

FIG. 6 illustrates an example computing system.

FIG. 7 illustrates a block diagram of an example processor and/or System on a Chip (SoC) that may have one or more cores and an integrated memory controller.

FIG. 8 is a block diagram illustrating a computing system configured to implement one or more aspects of the examples described herein.

FIG. 9A illustrates examples of a parallel processor.

FIG. 9B illustrates examples of a block diagram of a partition unit.

FIG. 9C illustrates examples of a block diagram of a processing cluster within a parallel processing unit.

FIG. 9D illustrates examples of a graphics multiprocessor in which the graphics multiprocessor couples with the pipeline manager of the processing cluster.

FIGS. 10A-10C illustrate additional graphics multiprocessors, according to examples.

FIG. 11 shows a parallel compute system 1100, according to some examples.

FIG. 12A is a block diagram illustrating both an example in-order pipeline and an example register renaming, out-of-order issue/execution pipeline according to examples.

FIG. 12B is a block diagram illustrating both an example in-order architecture core and an example register renaming, out-of-order issue/execution architecture core to be included in a processor according to examples.

FIG. 13 illustrates examples of execution unit(s) circuitry, such as execution unit(s) circuitry.

FIGS. 14A-14B illustrate thread execution logic including an array of processing elements employed in a graphics processor core according to examples described herein.

FIG. 15 is a block diagram of another example of a graphics processor.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “connected” means a direct electrical or magnetic connection between the things that are connected, without any intermediary devices, while the term of “coupled” means either a direct electrical or magnetic connection between the things that are connected or an indirect connection through one or more passive or active intermediary devices. The term “circuit” means one or more passive and/or active components that are arranged to cooperate with one another to provide a desired function. The terms “computing system,” “compute system,” “computer system,” and “computer” are used interchangeably herein. The term “set” means any positive whole number of items including one item.

### Coordinating Multiple Accelerators

Multiple accelerators may be integrated within a computing system. Embodiments of the disclosure implement a hardware-based architecture that enables scheduling requests to different accelerators of the computing system based on priorities of the requests. The priorities can be defined and applied using multiple granularities and embedded in the request descriptors in some embodiments. A scheduler can then schedule data to be processed using appropriate Quality-of-Service (QoS) schemes, e.g., based on service level agreements (SLAs) or service level objectives (SLOs).

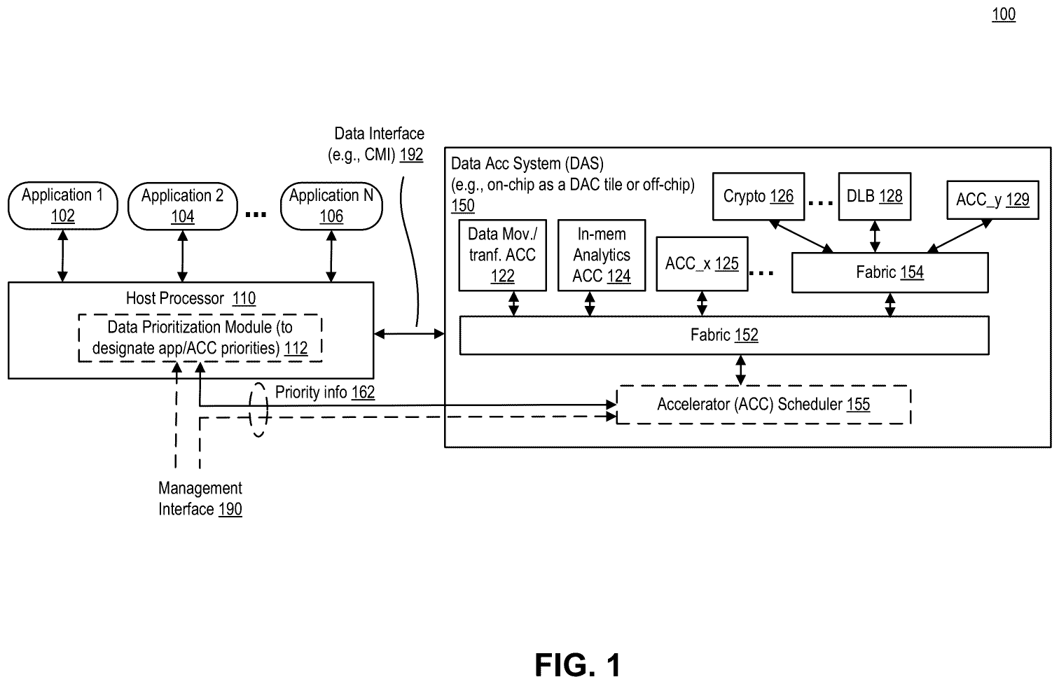

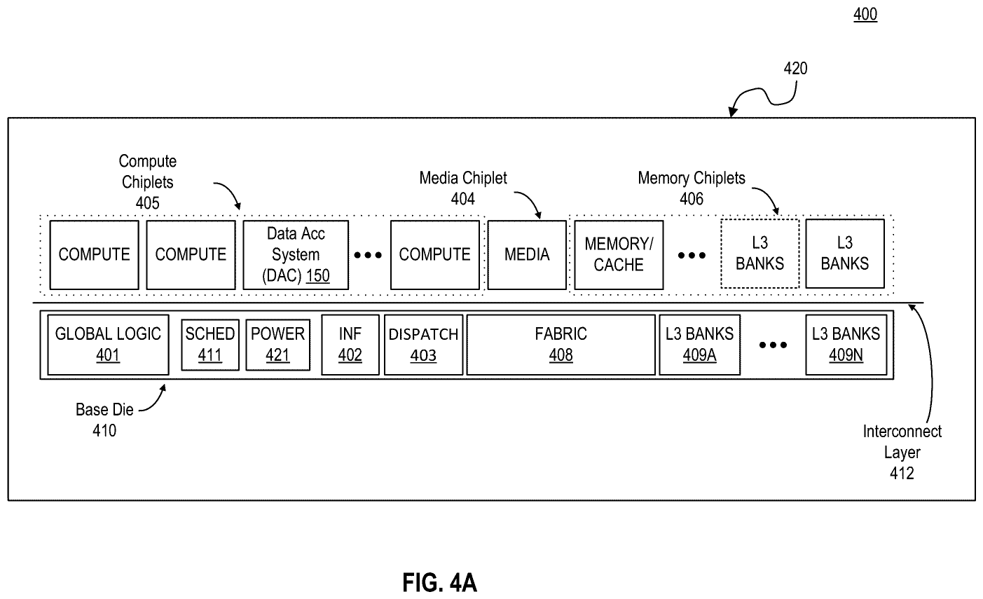

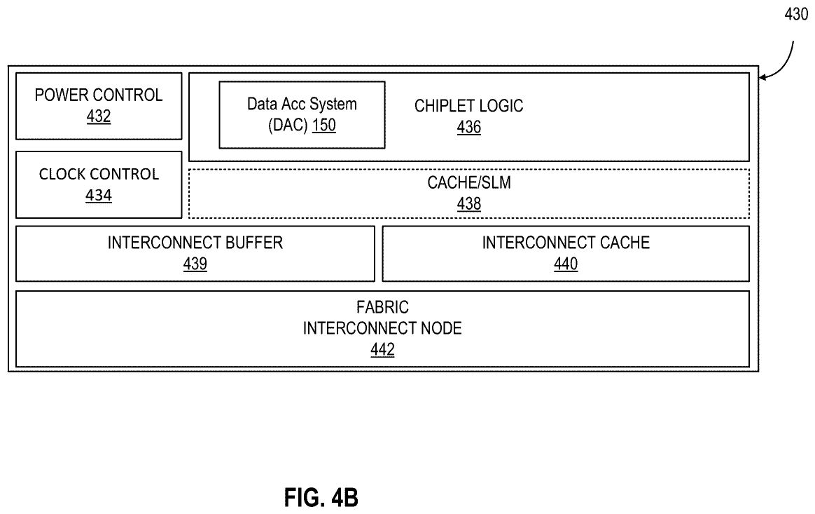

FIG. 1 illustrates entities for scheduling access to multiple accelerators of a computing system per some embodiments. System 100 may be a part of a computing system/processor discussed herein relating to FIGS. 4A-4B, and 6 to 14. System 100 includes a host processor 110 and a data accelerator system (DAS) 150 that includes multiple accelerators. Host processor 110 and DAS 150 may be coordinated by an Infrastructure processing unit (IPU) and/or Data processing unit (DPU) in some embodiments. The IPU and DPU may be designed to offload from the main CPU (e.g., host processor 110) the infrastructure-related tasks and data-centric tasks, respectively, to enhance the efficiency and performance of data centers and cloud environments.

The host processor 110 executes a number of applications 1 to N at references 102, 104, to 106, which may be executed through a host operating system (OS). Execution of an application may initiate one or more processes. While only applications are shown as the services supported, System 100 may support multi-tenant implementation where each accelerator, along with host processor 110, serves multiple applications, processes, microservices, or other types of tenants. In some embodiments, microservices are supported through Software-Defined Networking and/or Network Function Virtualization (NFV).

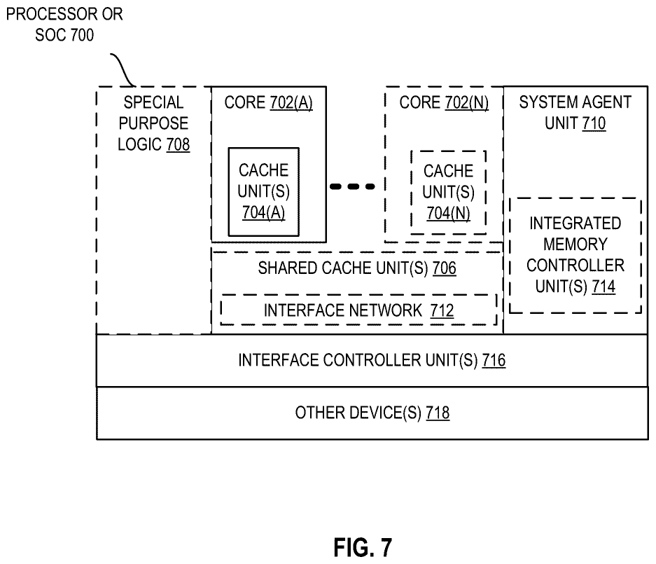

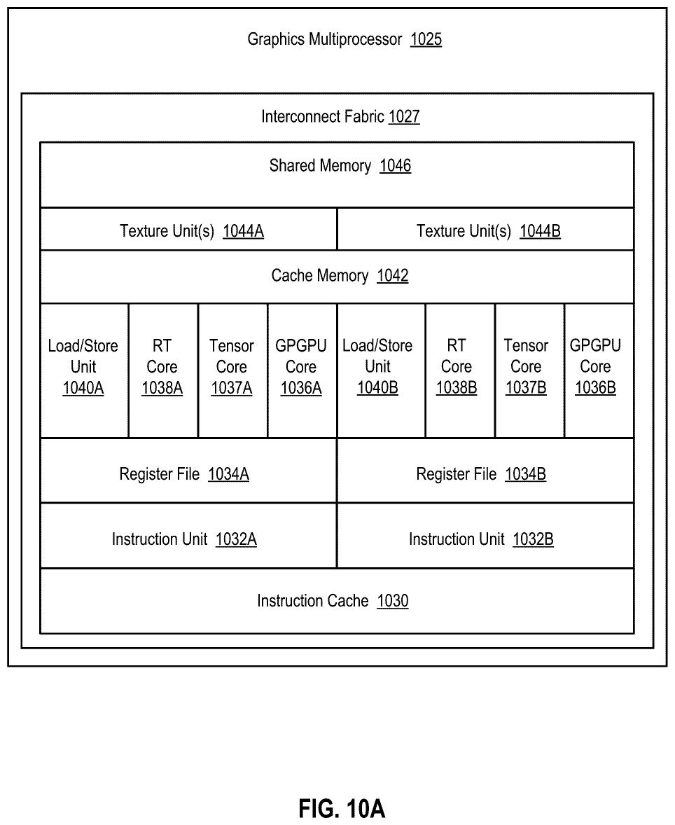

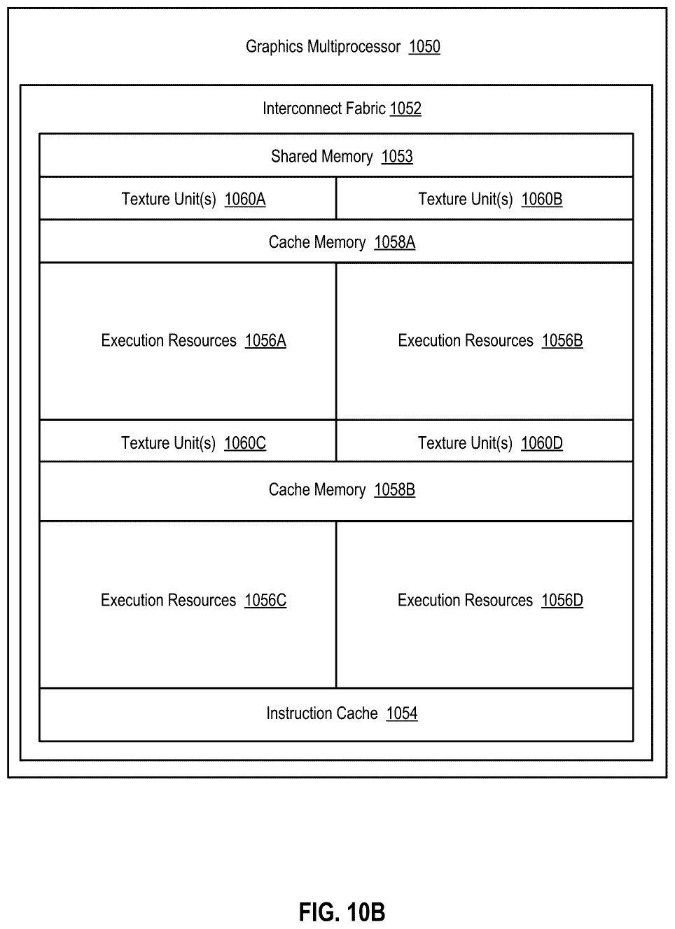

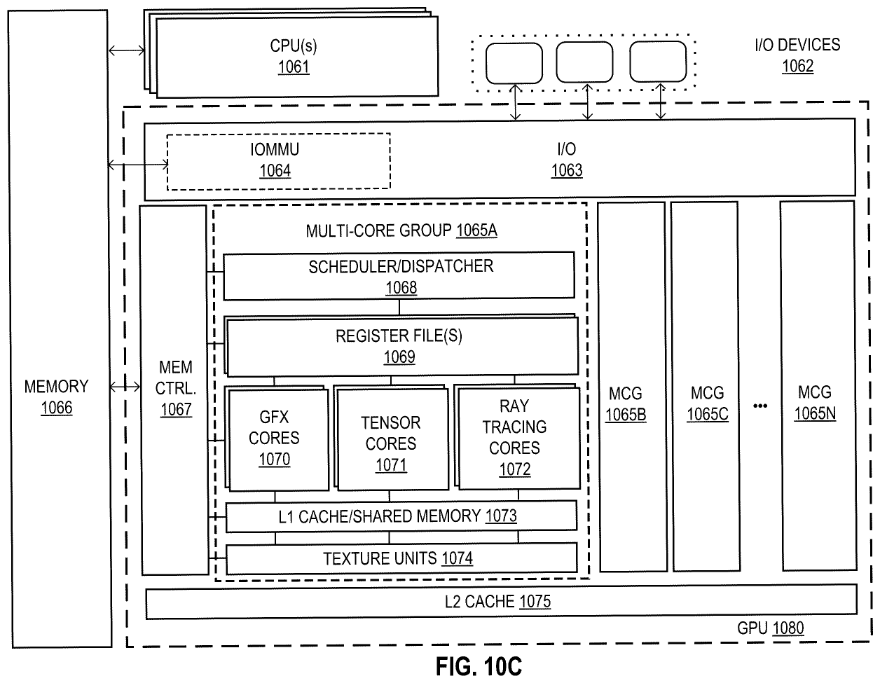

A host processor 110 is a primary component of system 100 responsible for executing instructions and performing data processing, and it may be one or more central processing units (CPUs) provided by specific vendors using their own instruction set architectures (ISAs) or an open-source ISA (e.g., Reduced Instruction Set Computing-V, RISC-V). Host processor 110 may include a plurality of cores (e.g., processor 700 in FIG. 7) or multi-core groups (e.g., GPU 1080 in FIG. 10C), and these cores may be homogenous or heterogenous with different architectures, performance characteristics, and/or functionalities (e.g., a set of performance cores and another set of efficiency cores). The host processor 110 and DAS 150 may communicate through an interconnect/fabric (e.g., a coherent mesh interface (CMI) 192) in some embodiments.

System 100 may include a System-on-Package (SoP) in some embodiments. The SoP may use a System on a Chip (SoC) or a Network on a Chip (NoC) in some embodiments. System 100 may be implemented using multiple chiplets (also referred to as tiles), where each processor or the set of processors and DAS 150 may be implemented on a chiplet. System 100 may be implemented on a multi-chip module, a multi-die package, an interposer-in-package, Silicon on Wafer (Si on Wafer), stacked dies/chiplets/silicon (e.g., die-to-die stacking including Foveros), or a single die, with interconnects/fabric such as embedded multi-die interconnect bridge (EMIB) and infinity fabric. The chiplets and interconnects/fabric are shown in more details relating to FIGS. 4A-4B, where each of host processor 110 and DAS 150 may be implemented on a compute chiplet 405.

DAS 150 includes multiple accelerators. DAS 150 may be integrated with the host processor 110 in a SoC as an on-chip complex, which may be referred to as a data accelerator complex (DAC) of the SoC. Alternatively/additionally, DAS 150 may also include one or more off-chip accelerators for specific tasks as well. An accelerator is a specialized hardware component of DAS 150 designed to offload from host processor 110 and accelerate specific tasks or workloads that are computationally intensive or require specialized processing. The accelerator may be a Graphics Processing Unit (GPU), a Field-Programmable Gate Array (FPGA), Application-Specific Integrated Circuit (ASIC), a Tensor Processing Unit (TPU) (e.g., for matrix computation used in machine learning), a Digital Signal Processor (DSP), a Neural Processing Unit (NPU) (e.g., for neural network computation) or any other type of Processing Unit (xPU) coupled to host processor 110 to perform corresponding specific tasks.

The accelerators included in DAS 150 may include a variety of types dedicated to different tasks for processing an application of System 100. For example, DAS 150 may include a data movement and transformation accelerator 122, also referred to as data streaming accelerator (DSA), that optimizes streaming data movement and transformation. For example, data movement and transformation accelerator 122 may enhance the performance and efficiency of processing continuous streams of data in real-time.

DAS 150 may further include an in-memory analytics (IAA) accelerator 124 that enhances the performance and efficiency of data analytics tasks by utilizing in-memory processing, including data compression, machine learning model training, data mining, and statistical analysis.

DAS 150 may also include a crypto accelerator 126 that performs cryptographic operations (encryption/decryption), machine learning and artificial intelligence (AI) inference, graphics rendering, media processing, scientific/data computing (e.g., matrix math calculation), database acceleration, networking and packet processing, and neuromorphic computing. In some embodiments, the crypto accelerator 126 includes a QuickAssist technology (QAT) logic/circuitry to compress data and/or perform encryption/decryption.

DAS 150 may additionally include a dynamic load balancer (DLB) to distribute load across cores (e.g., ones among multiple cores of host processor 110).

These and other accelerators, e.g., accelerator x at reference 125 and accelerator y at reference 129, are coupled with each other and other components within DAS 150 and other components of System 100 through fabrics/interconnects, e.g., fabrics 152 and 154 as shown. The accelerators may consume resources of DAS 150 when they process data. The resources include execution resources, storage resources, and bandwidth resources. For example, the execution resources may include parallel processing units of DAS 150; the storage resources may include memory and L1/L2/L3 cache of DAS 150 to store the data prior to and/or after being processed by the accelerators; and the bandwidth resources may include the bandwidth on fabric 152/154 to be allocated to the accelerators.

A data flow (or simply flow) represents a workload to be distributed/processed through a computing system such as System 100, and data within a data flow includes one or more header(s) that contain control information and a payload that contains actual data being transmitted or received. The data may be transmitted within a packet, a frame, a datagram, an Input or output (I/O) data, or a cell; a fragment of a frame, a fragment of a datagram, a fragment of a packet, or a fragment of a cell; or another type, arrangement, or packaging of data. While packets are often used as examples of the data/workload to be distributed/processed in a computing system to explain some embodiments, these embodiments may be implemented for data carried in other formats as well.

A hardware-based accelerator scheduler 155 (a hardware circuitry and/or logic) may be implemented within DAS 150 or outside but coupled to DAS 150 to schedule access to the accelerators so that data to be processed by the accelerators. The scheduling shapes the volume/processing rate to/from these accelerators according to prioritization. For example, when Application 1 (e.g., video game application) has a stricter latency requirement than Application 2 (e.g., weather forecast application), packets of Application 1 to be processed by crypto accelerator 126 may be assigned to a higher priority than packets of Application 2 to be processed by DLB 128. Additionally, packets within the same application may be prioritized among themselves regarding accessing to different accelerators of DAS 150. For example, a packet within Application 1 accessing DLB 128 may be given a higher priority than another packet within the same Application 1 accessing crypto accelerator 126 (e.g., due to load distribution by DLB 128 resulting in a lower latency, which is more critical for Application 1 than crypto operations by crypto accelerator 126).

The access scheduling by accelerator scheduler 155 may address the “noisy neighbor” problem in multi-tenant environments (e.g., cloud computing), where multiple applications/processes/microservices share the same physical hardware resources (e.g., the ones within DAS 150). Through access scheduling, an application may not monopolize the hardware resources to the detriment of other applications—a lower priority application may still be permitted to use resources (e.g., the ones proportional to its need to satisfy its SLA/SLO). Accelerator scheduler 155 thus may optimize resource allocation among the multiple applications/processes/microservices and provide better SLAs/SLOs for all applications on System 100 based on policies/rules for System 100 (e.g., aggregated SLAs/SLOs for all applications).

The priorities may be assigned/requested by applications, the system administrator, and/or a third party (e.g., through a management interface 190). For example, the priorities may be assigned based on the information provided by the applications themselves or orchestrators (e.g., Kubernetes) (e.g., based on the requested SLA/SLO). In some embodiments, a requested priority may be converted to another priority (e.g., based on system conditions or administrator preference/policy). The converted priority may or may not be exposed to the requester. In some embodiments, the priorities are assigned through a data prioritization module 112, which may be implemented within the host OS or as an application to interact with the host OS of a host processor 110. The priority information 162 may be provided to accelerator scheduler 155 by data prioritization module 112 or through management interface 190 directly.

In some embodiments, data prioritization module 112 may be secured to prevent abuse by a malicious user or a third party, the access security may be provided through hardware/software modules, such as Intel Trust Domain Extensions (TDX), AMD Secure Encrypted Virtualization (SEV), ARM Confidential Compute Architecture (CCA), Microsoft Virtualization-based Security (VBS), Google Confidential VMs, VMware vSphere with Trusted Execution Environment (TEE), or other secure environment.

The priority information 162 may be indicated at the application level, where each application has a priority level based on its SLA/SLO relative to other applications executed in System 100. The priority information 162 may be additionally/alternatively indicated at the accelerator level, where data is prioritized in using an accelerator. When both prioritization levels are used, the application-level prioritization may be viewed as coarse-grained as it applies to data of a whole application (or a process/microservice), while the accelerator level prioritization may be viewed as fine-grained as it applies to individual data (e.g., a packet or frame) of that application. In alternative embodiments, the accelerator level prioritization may be viewed as coarse-grained while the application-level prioritization as fine-grained (e.g., when full-utilization of the accelerators is more important). Additionally, other than the application level and accelerator level, other levels of prioritization may be implemented as well, e.g., an application may initiate multiple processes within System 100, and each process within the application may be mapped to a different priority. When microservices are used to process data, prioritization may be configured at microservice level in addition/alternative.

The multiple level prioritization offers more flexibility to achieve the desired SLAs and/or SLOs of the applications. The application and system administrators may manage accelerator priorities from different perspectives and granularities to satisfy inter-accelerator and intra-accelerator QoS requirements (e.g., requests from different applications to different accelerators and to the same accelerator), and inter-application and intra-application QoS requirements (e.g., requests from the same application to different accelerators or requests from different applications to the different accelerators).

Through the prioritization by accelerator scheduler 155, DAS 150 may schedule requests to process data for different accelerators when contention occurs. Through prioritization, DAS 150 may provide better performance and/or utilize resources of DAS 150 (and/or resources of accelerators within DAS 150) more efficiently.

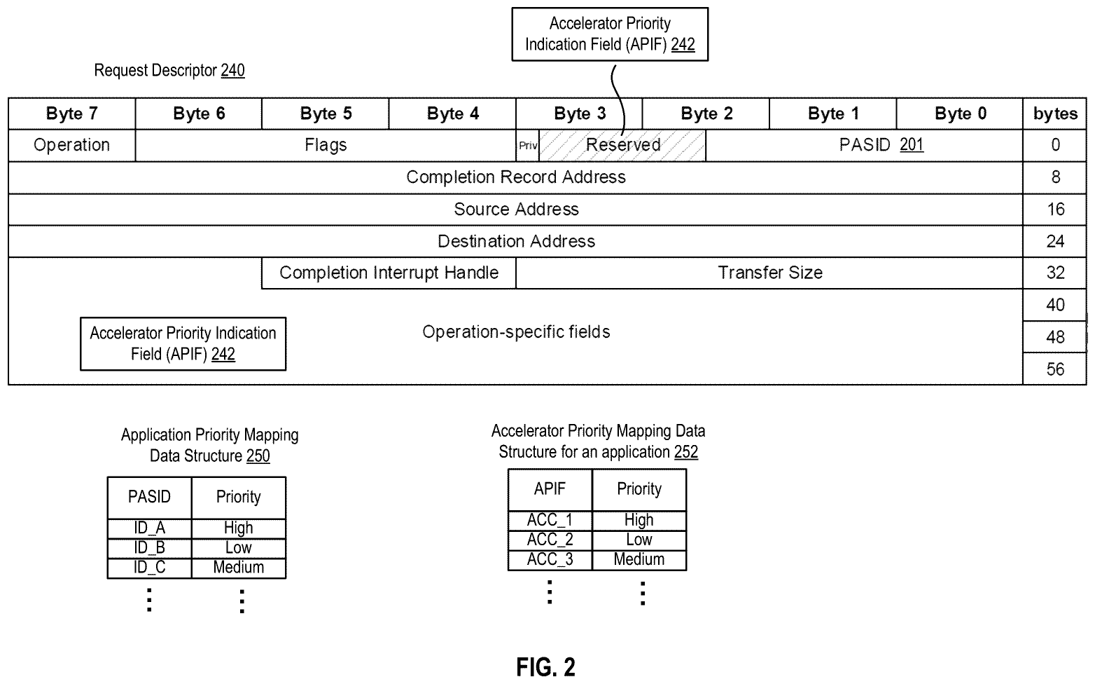

A request to process data to be issued to DAS 150 for an accelerator includes a request descriptor in some embodiments. FIG. 2 illustrates a request descriptor to request for an accelerator per some embodiments. Request descriptor 240 includes an operation field to indicate the operation to be performed; flags field to indicate status and/or control; a process address space identifier (PASID) field to indicate the PASID of the requested process; a complete record address field to indicate the address of the completion record; a source address field and a destination address field to indicate the source and destination addresses of the data, respectively; a complete interrupt handle field to indicate the interrupt table entry to be used to generate a completion interrupt; a transfer size field to indicate the number of bytes to be read from the source address to perform the operation; and an operation-specific field to provide specific information about the requested operation. More or less fields may be implemented in an alternative request descriptor.

The PASID field shown at reference 201 indicates a value used in memory transactions to convey the address space on a host processor (e.g., host processor 110) of an address to be used by an accelerator. The PASID is mapped to a corresponding application, which has data to be processed by an accelerator and for which the request descriptor is submitted. The PASID may thus be used to configure the priority of an application. A data structure may be constructed to indicate application priorities and shown as application priority mapping data structure 250, which includes entries each indicating an ID to identify the address space of an application and corresponding priority.

Additionally, the priority of an accelerator may be included in the request descriptor 240 as well. For example, the priority of an accelerator may be stored in an accelerator priority indication field (APIF) 242, and APIF 242 may be stored in a reserved field or the operation-specific fields. Another data structure, accelerator priority mapping data structure for an application 252, may be used to configure the priority of an accelerator. The data structure 252 includes entries each indicating an ID to identify an accelerator of DAS 150 and corresponding priority. In some embodiments, the data structure 252 maps to a specific application or a group of applications, e.g., another field of an entry in the data structure 252 indicating the mapping application or group of applications. The specific application mapping aligns with the fine-grained accelerator level prioritization discussed herein for the specific data to be processed corresponding to the request descriptor in some embodiments. While three levels of priorities are shown in both data structures of FIG. 2, these data structures may have different levels of priorities and the priorities may be indicated using other values (e.g., integers each indicating a level of priority).

Each of the two data structures may be implemented as a table, a map, a dictionary, a list, an array, a file, a tally, a scoreboard, or an indicium. The data structure may be stored in a database/datastore in some embodiments. Each data structure may be stored in one or more registers of a computing system such as System 100. In some embodiments, the data structures are stored within data prioritization module 112.

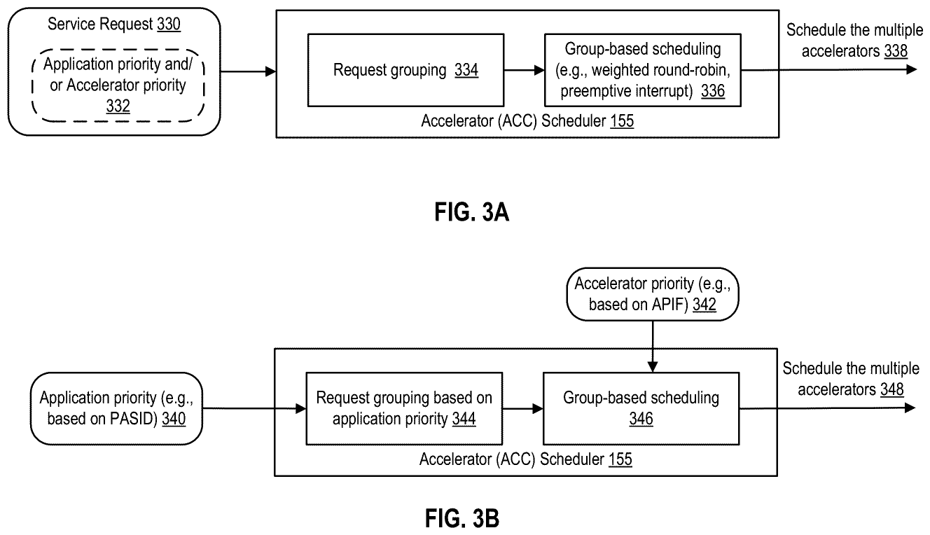

FIGS. 3A-3B illustrate the operations of scheduling for multiple accelerators per embodiments. FIG. 3A illustrates an embodiment to implement single level or multiple-level prioritization. A service request 330 is issued to the accelerator scheduler 155. The service request 330 may be issued through host processor 110 and incorporate the one or more priorities assigned by data prioritization module 112. The service request 330 may indicate an application for which the service request is issued and an accelerator to which data is to be processed/transformed to fulfill the service request. The priority of the application and the priority of accelerator may be obtained through a lookup of application priority mapping data structure 250 and accelerator priority mapping data structure for an application 252, respectively, based on the service request 330. The obtained priority of the application and the priority of accelerator are shown at reference 332, indicating that the priorities may be obtained prior to the request arriving at accelerator scheduler 155. Alternatively, accelerator scheduler 155 may obtain the priorities based on the service request 330, e.g., by looking up application priority mapping data structure 250 and accelerator priority mapping data structure for an application 252. The obtained priority indication allows multiple requests from different applications to access the same/different accelerators to share resources (e.g., ones within DAS 150) efficiently. When two requests need to use particular resources simultaneously, the relative priority between the requests may be used to prioritize the use of the resources.

In some embodiments, the service request 330 may be grouped at reference 334 into a group with other service requests that are mapped to the same application priority and/or the same accelerator priorities. Accelerator scheduler 155 then performs a group-based scheduling at reference 336 to process data corresponding to the service requests within the groups. When multiple level prioritization is supported, the coarser grained prioritization forms groups while the finer grained prioritization forms sub-groups within a group. Based on the grouping and subgrouping, the service requests may be queued in their respective buffers and corresponding data may be routed to their respective service accelerators based on the queuing positions of services requests.

The group-based scheduling may process the service requests using a weighed round-robin approach and check the queues one-by-one and dequeue requests from the queues based on their different priorities. The scheduling may use a preemptive approach, that is, whenever there is request in a certain queue, that queue is always dequeued first due the corresponding priority/prioritization indicated by the enqueued service requests. These two approaches are for different QoS requirements and can be implemented together. Accelerator scheduler 155 thus schedules dataprocessing/transformation at reference 338 of the multiple accelerators within DAS 150.

FIG. 3B illustrates an embodiment to implement a multiple-level prioritization per some embodiments. At reference 340, the application priority of a service request is provided to accelerator scheduler 155. The application priority may be based on the PASID value of a request descriptor. The service request is grouped into a group at reference 344 with other service requests that are mapped to the same application priority. To further differentiate the service requests mapped to the same application, accelerator priority 342 is used to separate the service requests of the same application into different subgroups. For example, each subgroup is used to queue service requests for the accelerators with the same accelerator priority. The group-based scheduling may then be used at reference 346 to schedule the multiple accelerators at reference 348 based on the priorities of the groups/subgroups.

### Chiplet-Based Implementation

The embodiments may be implemented in a variety of computing systems, including ones with chiplet-based design. FIGS. 4A-4B illustrate a hybrid logical/physical view of a disaggregated parallel processor to schedule access to multiple accelerators per some embodiments. FIG. 4A illustrates a disaggregated parallel computing system 400. FIG. 4B illustrates a chiplet 430 of the disaggregated parallel computing system 400.

As shown in FIG. 4A, a disaggregated parallel computing system 400 can include a parallel processor 420 in which the various components of the parallel processor SoC are distributed across multiple chiplets. Each chiplet can be a distinct IP core that is independently designed and configured to communicate with other chiplets via one or more common interfaces. The chiplets include, but are not limited to, compute chiplets 405, a media chiplet 404, and memory chiplets 406. Each chiplet can be separately manufactured using different process technologies. For example, compute chiplets 405 may be manufactured using the smallest or most advanced process technology available at the time of fabrication, while memory chiplets 406 or other chiplets (e.g., I/O, networking, etc.) may be manufactured using larger or less advanced process technologies. One or more of the chiplets, e.g., compute chiplets 405 may include one implement DAS 150 while another compute chiplet may implement host processor 110 in some embodiments.

In some embodiments, multiple compute chiplets 405 may each implement an instance of data accelerator system (DAS) 150, and the access scheduling may include forwarding a request to the DAS instance with more available resources to serve the request. A DAS instance (e.g., Accelerator scheduler 155 within the instance) may determine whether to schedule access to the DAS instance or forward the request to another DAS instance. For example, the DAS instance may try to schedule access to itself first and when no sufficient resources available to serve the quest (through the embodiments discussed herein relating o FIGS. 1 to 3), forward the request to another DAS instance with the needed resources. In some embodiments, each DAS instance indicates its resource availability for other entities (e.g., other DAS instances or host processor) to schedule requests. The forwarding among DAS instances may be referred to as topology-aware access scheduling and may be used along with the access scheduling within an DAS instance (as the ones shown for DAS 150).

The various chiplets can be bonded to a base die 410 and configured to communicate with each other and logic within the base die 410 via an interconnect layer 412. In some examples, the base die 410 can include global logic 401, which can include scheduler 411 and power management 421 logic units, an interface 402, a dispatch unit 403, and an interconnect fabric module 408 coupled with or integrated with one or more L3 cache banks 409A-409N. The interconnect fabric 408 can be an inter-chiplet fabric that is integrated into the base die 410. Logic chiplets can use fabric 408 to relay messages between the various chiplets. Additionally, L3 cache banks 409A-409N in the base die and/or L3 cache banks within the memory chiplets 406 can cache data read from and transmitted to DRAM chiplets within the memory chiplets 406 and to system memory of a host.

In some examples, the global logic 401 is a microcontroller that can execute firmware to perform scheduler 411 and power management 421 functionality for the parallel processor 420. The microcontroller that executes the global logic can be tailored for the target use case of the parallel processor 420. The scheduler 411 can perform global scheduling operations for the parallel processor 420. The power management 421 functionality can be used to enable or disable individual chiplets within the parallel processor when those chiplets are not in use.

The various chiplets of the parallel processor 420 can be designed to perform specific functionality that, in existing designs, would be integrated into a single die. A set of compute chiplets 405 can include clusters of compute units (e.g., execution units, streaming multiprocessors, etc.) that include programmable logic to execute compute or graphics shader instructions. A media chiplet 404 can include hardware logic to accelerate media encode and decode operations. Memory chiplets 406 can include volatile memory (e.g., DRAM) and one or more SRAM cache memory banks (e.g., L3 banks).

As shown in FIG. 4B, each chiplet 430 can include common components and application specific components. Chiplet logic 436 within the chiplet 430 can include the specific components of the chiplet, such as an array of streaming multiprocessors, compute units, or execution units described herein. The chiplet logic 436 can couple with an optional cache or shared local memory 438 or can include a cache or shared local memory within the chiplet logic 436. The chiplet 430 can include a fabric interconnect node 442 that receives commands via the inter-chiplet fabric. Commands and data received via the fabric interconnect node 442 can be stored temporarily within an interconnect buffer 439. Data transmitted to and received from the fabric interconnect node 442 can be stored in an interconnect cache 440. Power control 432 and clock control 434 logic can also be included within the chiplet. The power control 432 and clock control 434 logic can receive configuration commands via the fabric, and they can configure dynamic voltage and frequency scaling for the chiplet 430. In some examples, each chiplet can have an independent clock domain and power domain and can be clock gated and power gated independently of other chiplets. In some embodiments, DAS 150 is implemented within chiplet logic 436.

At least a portion of the components within the illustrated chiplet 430 can also be included within logic embedded within the base die 410 of FIG. 4A. For example, logic within the base die that communicates with the fabric can include a version of the fabric interconnect node 442. Base die logic that can be independently clock or power gated can include a version of the power control 432 and/or clock control 434 logic.

Thus, while various examples described herein use the term SoC to describe a device or system having a processor and associated circuitry (e.g., Input/Output (I/O) circuitry, power delivery circuitry, memory circuitry, etc.) integrated monolithically into a single Integrated Circuit (IC) die, or chip, the present disclosure is not limited in that respect. For example, in various examples of the present disclosure, a device or system can have one or more processors (e.g., one or more processor cores) and associated circuitry (e.g., Input/Output (I/O) circuitry, power delivery circuitry, etc.) arranged in a disaggregated collection of discrete dies, tiles, and/or chiplets (e.g., one or more discrete processor core die arranged adjacent to one or more other die such as memory die, I/O die, etc.). In such disaggregated devices and systems, the various dies, tiles, and/or chiplets can be physically and electrically coupled together by a package structure including, for example, various packaging substrates, interposers, active interposers, photonic interposers, interconnect bridges, and the like. The disaggregated collection of discrete dies, tiles, and/or chiplets can also be part of a System-on-Package (SoP).

### Operations in Some Embodiments

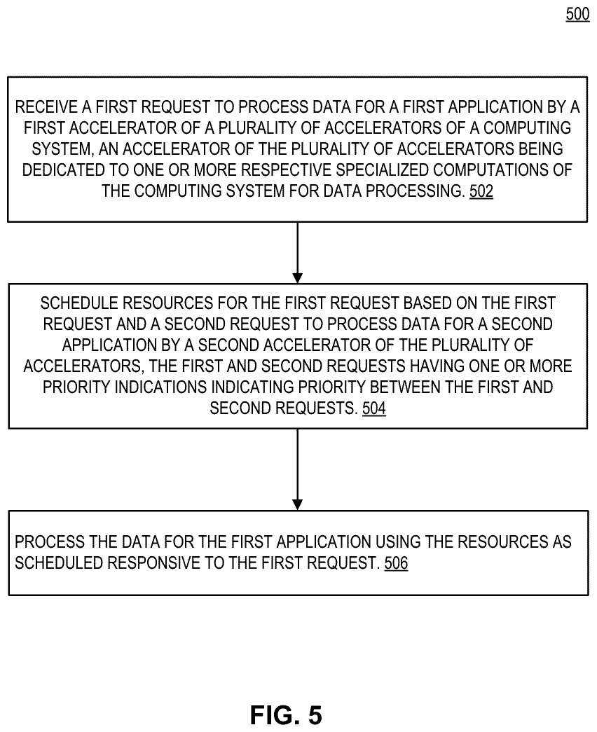

FIG. 5 illustrates a flow diagram for operations to schedule access to multiple accelerators per some embodiments. The operations in method 500 may be performed by an accelerator scheduler (e.g., accelerator scheduler 155) of a computing system (e.g., System 100) discussed herein in some embodiments.

At reference 502, a first request is received to process data for a first application by an accelerator of a plurality of accelerators of a computing system, an accelerator of the plurality of accelerators being dedicated to one or more respective specialized computations of the computing system for data processing. At reference 504, resources are scheduled for the first request based on the first request and a second request to process data for a second application by a second accelerator of the plurality of accelerators, the first and second requests having one or more priority indications indicating priority between the first and second requests. At reference 506, the data for the first application is processed using the resources as scheduled responsive to the first request.

In some embodiments, the resources include one or more of execution resources, storage resources, and bandwidth resources as discussed herein. The plurality of accelerators is implemented in a data accelerator system (e.g., DAS 150) in some embodiments. In some embodiments, the plurality of accelerators is implemented in an on-chip accelerator complex of the computing system.

In some embodiments, the first request comprises a descriptor identifying the first application, an operation to be performed on the data by the first accelerator, and source and destination of the data for the first application. In some embodiments, the descriptor is the request descriptor 240. In some embodiments, the application is mapped to a priority of the application.

In some embodiments, a first data structure is maintained to track mapping between applications and respective application priorities, an entry in the first data structure indicating the first application and the priority of the first application.

In some embodiments, scheduling the resources for the first request comprises selecting a group of applications to assign the first request from a plurality of groups of applications with respective application priorities, the group of applications mapping to the priority.

In some embodiments, processing the data for the first application using the resources comprises exhausting requests within the group of applications prior to processing data for one or more requests within another group of applications that have a lower priority. In some embodiments, processing the data using the resources comprises processing requests of the plurality of groups on a weighted round-robin basis, where requests from the group of applications are favored with a larger weight over requests from another group of applications that have a lower priority. The preemptive approach and weighted round-robin approach are discussed above relating to FIG. 3B.

In some embodiments, the descriptor further includes a field indicating a priority to use the first accelerator by the first request. In some embodiments, a second data structure is maintained to track mapping between accelerators and priorities to use the respective accelerators, an entry in the second data structure for the first application indicating the first accelerator and the priority to use the first accelerator.

In some embodiments, processing the data for the first application using the resources comprises prioritizing the first request for the first application through the first accelerator over another request with a lower priority to use the first accelerator based comparing priority indications of the request and the another request in the field.

In some embodiments, the one or more priority indications include a first indication to specify a first priority for the first application and a second indication to specify a second priority to use the first accelerator by the first request; wherein the first indication is used to select a group of applications to assign the first request from a plurality of groups of applications with respective application priorities, the group mapped to the first priority; and wherein the second indication is used to prioritize the first request and another request within the group of applications.

In some embodiments, scheduling the resources for the first request based on the one or more priority indications corresponding to the first request is performed by a circuitry within an accelerator complex.

Embodiments of the disclosure herein provide accelerator scheduling of multiple accelerators within an accelerator system to enhance the computing system performance and utilize the multiple accelerators more efficiently. By addressing content of resources in using the multiple accelerators, the embodiments provide a flexible scheme to mitigate performance issues with the multiple accelerators in the same computing system.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices are also suitable.

In general, a variety of systems or electronic devices capable of incorporating a processor and/or other execution logic as disclosed herein are generally suitable, and the embodiments are not limited to these exemplary systems and processors.

### Example Systems

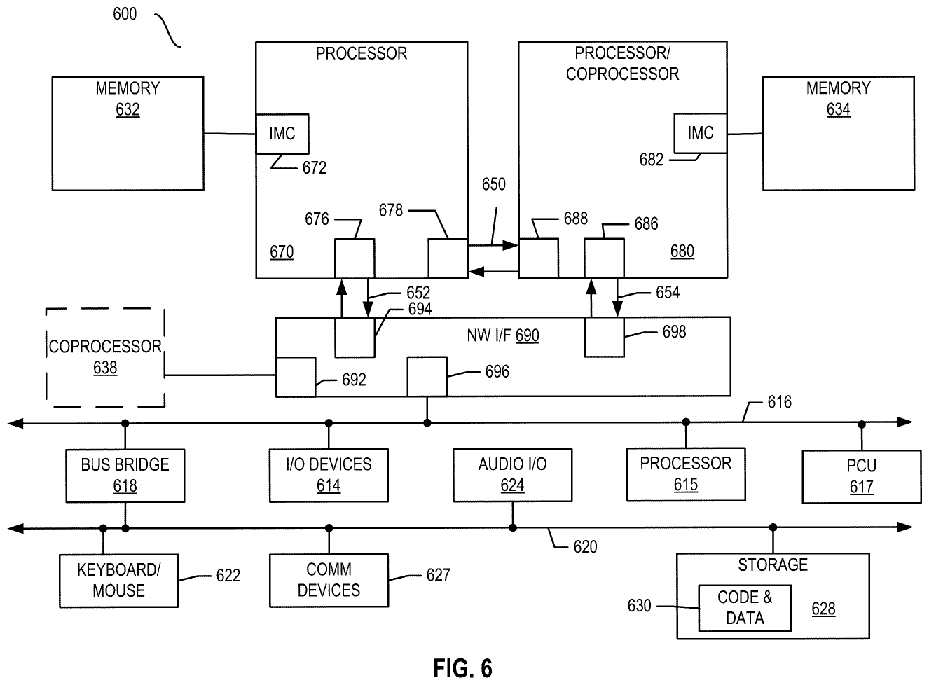

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, mesh, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect Express (PCIe) interconnect, Compute Express Link (CXL), NVLink, HyperTransport, or another I/O interconnect. In some examples, first interface 616 is coupled to a power control unit (PCU) 617, which may include circuitry, software, and/or firmware to perform power management operations with regard to the processors 670, 680 and/or coprocessor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to the second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement a storage in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

In some examples, System 100 is virtualized or “sliced” to allow multiple virtual machines access to the same physical hardware while maintaining access control. This virtualization may be implemented using Scalable IOV (SIOV), Single Root I/O Virtualization (SR-IOV) or the like to create virtual device interfaces, while isolating domains, and sharing a device as an Assignable Device Interface (ADI).

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or coprocessor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

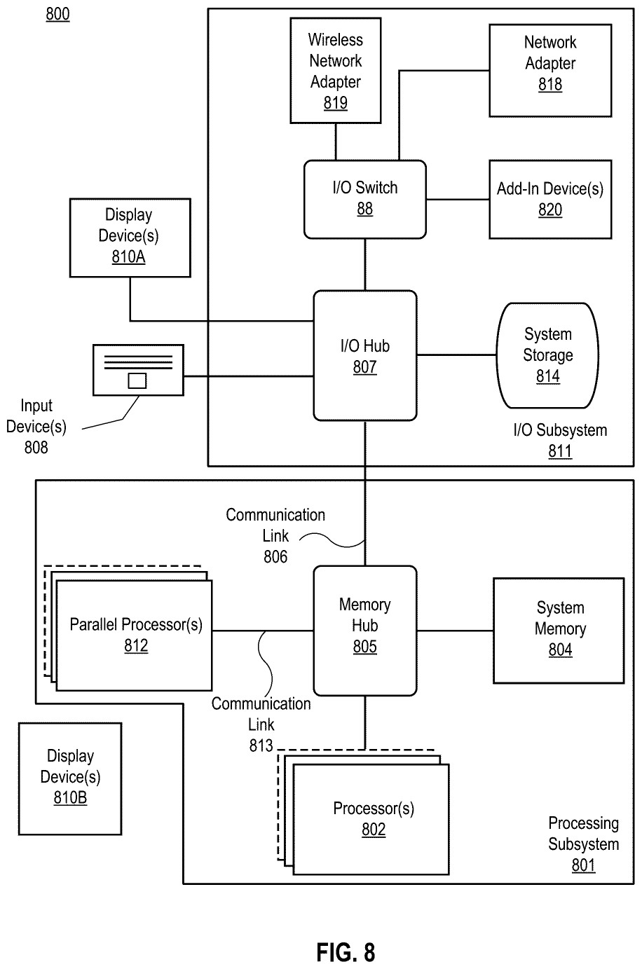

FIG. 8 is a block diagram illustrating a computing system 800 configured to implement one or more aspects of the examples described herein. The computing system 800 includes a processing subsystem 801 having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link 806. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or other communication link 813. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Universal Chiplet Interconnect Express (UCIe), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8. For example, the memory hub 805 may be referred to as a Northbridge in some architectures, while the I/O hub 807 may be referred to as a Southbridge.

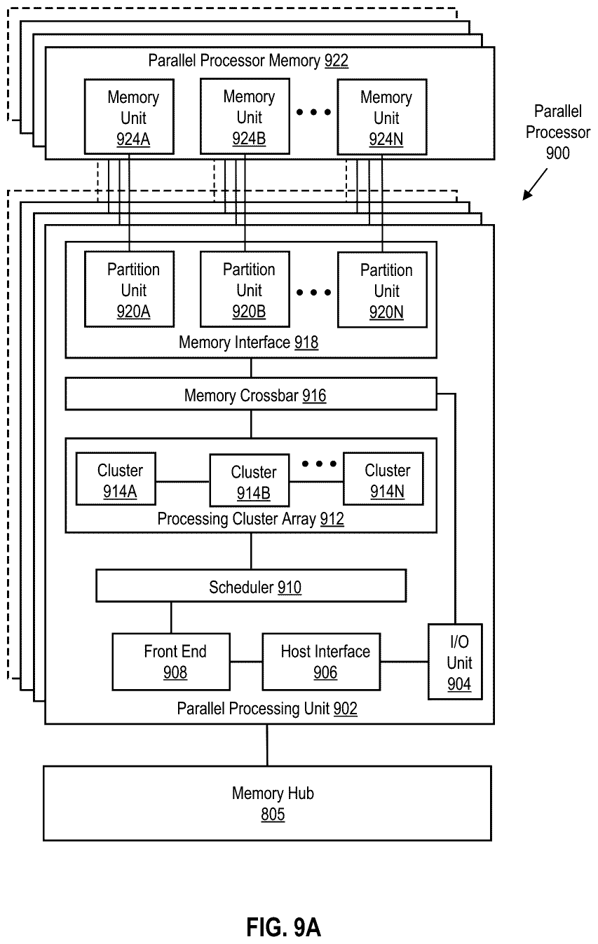

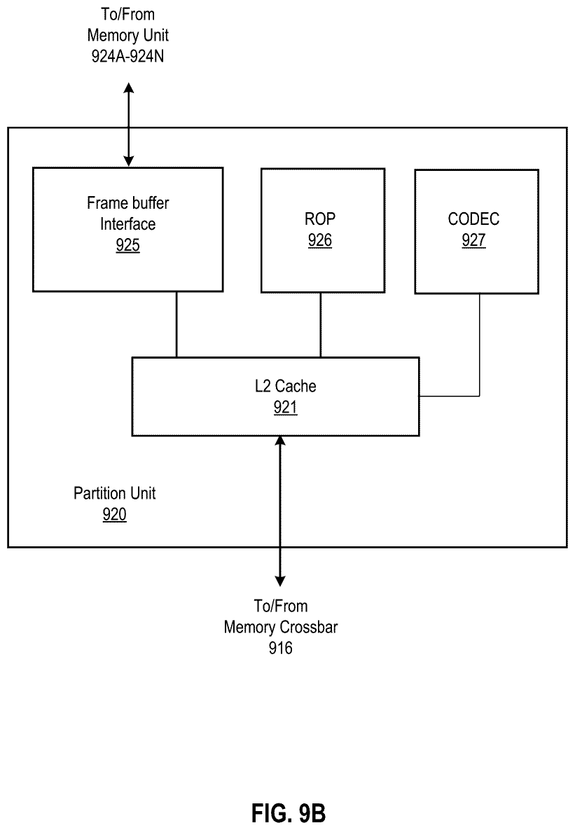

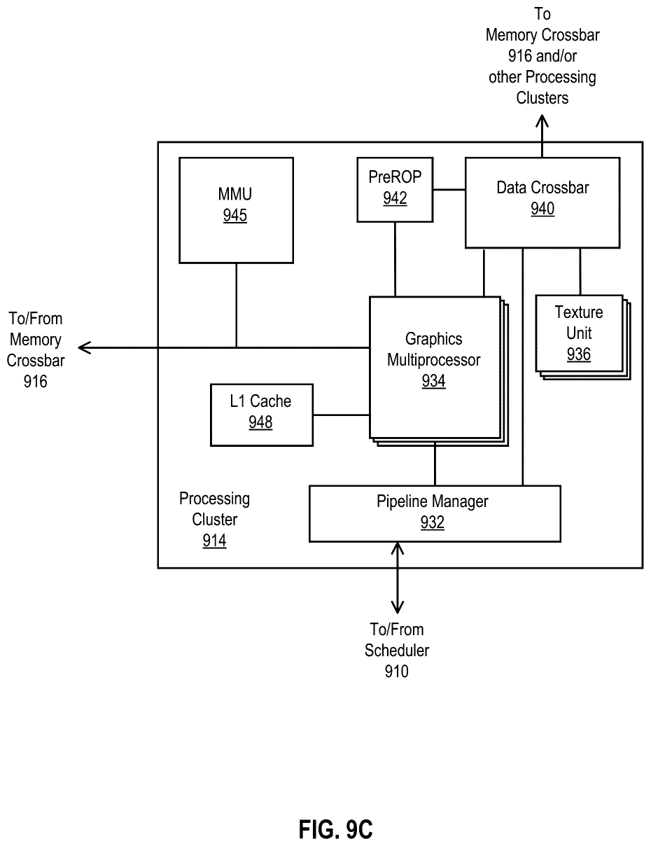

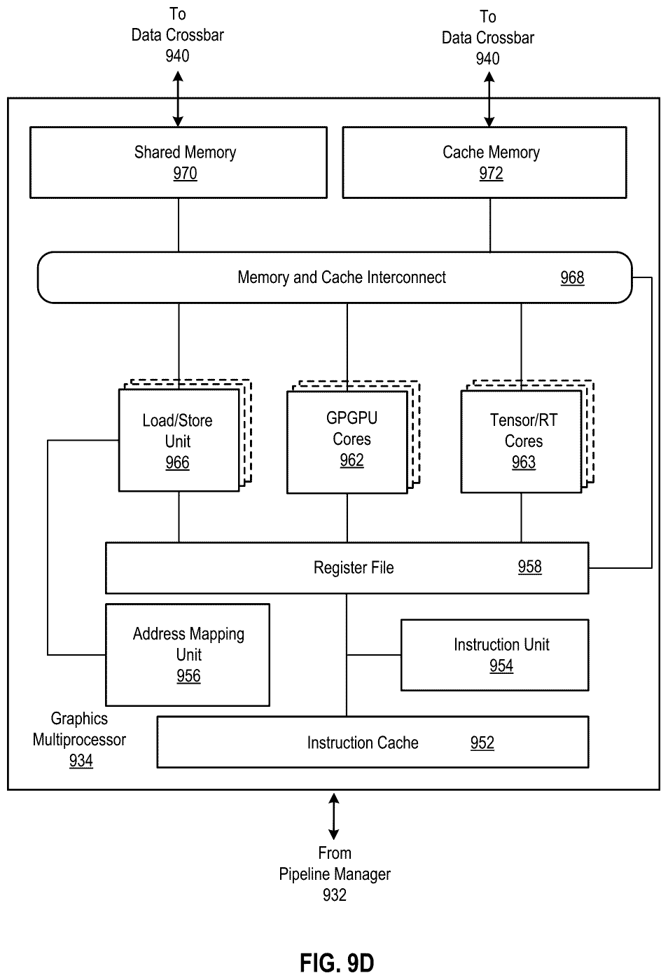

FIG. 9A illustrates examples of a parallel processor 900. The parallel processor 900 may be a GPU, GPGPU or the like as described herein. The various components of the parallel processor 900 may be implemented using one or more integrated circuit devices, such as programmable processors, application specific integrated circuits (ASICs), or field programmable gate arrays (FPGA). The illustrated parallel processor 900 may be one or more of the parallel processor(s) 812 shown in FIG. 8.

The parallel processor 900 includes a parallel processing unit 902. The parallel processing unit includes an I/O unit 904 that enables communication with other devices, including other instances of the parallel processing unit 902. The I/O unit 904 may be directly connected to other devices. For instance, the I/O unit 904 connects with other devices via the use of a hub or switch interface, such as memory hub 805. The connections between the memory hub 805 and the I/O unit 904 form a communication link 813. Within the parallel processing unit 902, the I/O unit 904 connects with a host interface 906 and a memory crossbar 916, where the host interface 906 receives commands directed to performing processing operations and the memory crossbar 916 receives commands directed to performing memory operations.

When the host interface 906 receives a command buffer via the I/O unit 904, the host interface 906 can direct work operations to perform those commands to a front end 908. In some examples the front end 908 couples with a scheduler 910, which is configured to distribute commands or other work items to a processing cluster array 912. The scheduler 910 ensures that the processing cluster array 912 is properly configured and in a valid state before tasks are distributed to the processing clusters of the processing cluster array 912. The scheduler 910 may be implemented via firmware logic executing on a microcontroller. The microcontroller implemented scheduler 910 is configurable to perform complex scheduling and work distribution operations at coarse and fine granularity, enabling rapid preemption and context switching of threads executing on the processing cluster array 912. Preferably, the host software can prove workloads for scheduling on the processing cluster array 912 via one of multiple graphics processing doorbells. In other examples, polling for new workloads or interrupts can be used to identify or indicate availability of work to perform. The workloads can then be automatically distributed across the processing cluster array 912 by the scheduler 910 logic within the scheduler microcontroller.

The processing cluster array 912 can include up to “N” processing clusters (e.g., cluster 914A, cluster 914B, through cluster 914N). Each cluster 914A-914N of the processing cluster array 912 can execute a large number of concurrent threads. The scheduler 910 can allocate work to the clusters 914A-914N of the processing cluster array 912 using various scheduling and/or work distribution algorithms, which may vary depending on the workload arising for each type of program or computation. The scheduling can be handled dynamically by the scheduler 910 or can be assisted in part by compiler logic during compilation of program logic configured for execution by the processing cluster array 912. Optionally, different clusters 914A-914N of the processing cluster array 912 can be allocated for processing different types of programs or for performing different types of computations.

The processing cluster array 912 can be configured to perform various types of parallel processing operations. For example, the processing cluster array 912 is configured to perform general-purpose parallel compute operations. For example, the processing cluster array 912 can include logic to execute processing tasks including filtering of video and/or audio data, performing modeling operations, including physics operations, and performing data transformations.

The processing cluster array 912 is configured to perform parallel graphics processing operations. In such examples in which the parallel processor 900 is configured to perform graphics processing operations, the processing cluster array 912 can include additional logic to support the execution of such graphics processing operations, including, but not limited to texture sampling logic to perform texture operations, as well as tessellation logic and other vertex processing logic. Additionally, the processing cluster array 912 can be configured to execute graphics processing related shader programs such as, but not limited to vertex shaders, tessellation shaders, geometry shaders, and pixel shaders. The parallel processing unit 902 can transfer data from system memory via the I/O unit 904 for processing. During processing the transferred data can be stored to on-chip memory (e.g., parallel processor memory 922) during processing, then written back to system memory.

In examples in which the parallel processing unit 902 is used to perform graphics processing, the scheduler 910 may be configured to divide the processing workload into approximately equal sized tasks, to better enable distribution of the graphics processing operations to multiple clusters 914A-914N of the processing cluster array 912. In some of these examples, portions of the processing cluster array 912 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 914A-914N may be stored in buffers to allow the intermediate data to be transmitted between clusters 914A-914N for further processing.

During operation, the processing cluster array 912 can receive processing tasks to be executed via scheduler 910, which receives commands defining processing tasks from front end 908. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 910 may be configured to fetch the indices corresponding to the tasks or may receive the indices from the front end 908. The front end 908 can be configured to ensure the processing cluster array 912 is configured to a valid state before the workload specified by incoming command buffers (e.g., batch-buffers, push buffers, etc.) is initiated.

Each of the one or more instances of the parallel processing unit 902 can couple with parallel processor memory 922. The parallel processor memory 922 can be accessed via the memory crossbar 916, which can receive memory requests from the processing cluster array 912 as well as the I/O unit 904. The memory crossbar 916 can access the parallel processor memory 922 via a memory interface 918. The memory interface 918 can include multiple partition units (e.g., partition unit 920A, partition unit 920B, through partition unit 920N) that can each couple to a portion (e.g., memory unit) of parallel processor memory 922. The number of partition units 920A-920N may be configured to be equal to the number of memory units, such that a first partition unit 920A has a corresponding first memory unit 924A, a second partition unit 920B has a corresponding second memory unit 924B, and an Nth partition unit 920N has a corresponding Nth memory unit 924N. In other examples, the number of partition units 920A-920N may not be equal to the number of memory devices.

The memory units 924A-924N can include various types of memory devices, including dynamic random-access memory (DRAM) or graphics random access memory, such as synchronous graphics random access memory (SGRAM), including graphics double data rate (GDDR) memory. Optionally, the memory units 924A-924N may also include 3D stacked memory, including but not limited to high bandwidth memory (HBM). Persons skilled in the art will appreciate that the specific implementation of the memory units 924A-924N can vary and can be selected from one of various conventional designs. Render targets, such as frame buffers or texture maps may be stored across the memory units 924A-924N, allowing partition units 920A-920N to write portions of each render target in parallel to efficiently use the available bandwidth of parallel processor memory 922. In some examples, a local instance of the parallel processor memory 922 may be excluded in favor of a unified memory design that utilizes system memory in conjunction with local cache memory.

Optionally, any one of the clusters 914A-914N of the processing cluster array 912 has the ability to process data that will be written to any of the memory units 924A-924N within parallel processor memory 922. The memory crossbar 916 can be configured to transfer the output of each cluster 914A-914N to any partition unit 920A-920N or to another cluster 914A-914N, which can perform additional processing operations on the output. Each cluster 914A-914N can communicate with the memory interface 918 through the memory crossbar 916 to read from or write to various external memory devices. In one of the examples with the memory crossbar 916 the memory crossbar 916 has a connection to the memory interface 918 to communicate with the I/O unit 904, as well as a connection to a local instance of the parallel processor memory 922, enabling the processing units within the different processing clusters 914A-914N to communicate with system memory or other memory that is not local to the parallel processing unit 902. Generally, the memory crossbar 916 may, for example, be able to use virtual channels to separate traffic streams between the clusters 914A-914N and the partition units 920A-920N.

While a single instance of the parallel processing unit 902 is illustrated within the parallel processor 900, any number of instances of the parallel processing unit 902 can be included. For example, multiple instances of the parallel processing unit 902 can be provided on a single add-in card, or multiple add-in cards can be interconnected. For example, the parallel processor 900 can be an add-in device, such as add-in device 820 of FIG. 8, which may be a graphics card such as a discrete graphics card that includes one or more GPUs, one or more memory devices, and device-to-device or network or fabric interfaces. The different instances of the parallel processing unit 902 can be configured to inter-operate even if the different instances have different numbers of processing cores, different amounts of local parallel processor memory, and/or other configuration differences. Optionally, some instances of the parallel processing unit 902 can include higher precision floating point units relative to other instances. Systems incorporating one or more instances of the parallel processing unit 902 or the parallel processor 900 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 902 can be partitioned into multiple instances. Those multiple instances can be configured to execute workloads associated with different clients in an isolated manner, enabling a pre-determined quality of service to be provided for each client. For example, each cluster 914A-914N can be compartmentalized and isolated from other clusters, allowing the processing cluster array 912 to be divided into multiple compute partitions or instances. In such configuration, workloads that execute on an isolated partition are protected from faults or errors associated with a different workload that executes on a different partition. The partition units 920A-920N can be configured to enable a dedicated and/or isolated path to memory for the clusters 914A-914N associated with the respective compute partitions. This datapath isolation enables the compute resources within a partition can communicate with one or more assigned memory units 924A-924N without being subjected to inference by the activities of other partitions.

FIG. 9B is a block diagram of a partition unit 920. The partition unit 920 may be an instance of one of the partition units 920A-920N of FIG. 9A. As illustrated, the partition unit 920 includes an L2 cache 921, a frame buffer interface 925, and a ROP 926 (raster operations unit). The L2 cache 921 is a read/write cache that is configured to perform load and store operations received from the memory crossbar 916 and ROP 926. Read misses and urgent write-back requests are output by L2 cache 921 to frame buffer interface 925 for processing. Updates can also be sent to the frame buffer via frame buffer interface 925 for processing. In some examples the frame buffer interface 925 interfaces with one of the memory units in parallel processor memory, such as the memory units 924A-924N of FIG. 9A (e.g., within parallel processor memory 922). The partition unit 920 may additionally or alternatively also interface with one of the memory units in parallel processor memory via a memory controller (not shown).

In graphics applications, the ROP 926 is a processing unit that performs raster operations such as stencil, z test, blending, and the like. ROP 926 then outputs processed graphics data that is stored in graphics memory. In some examples the ROP 926 includes or couples with a CODEC 927 that includes compression logic to compress depth or color data that is written to memory or the L2 cache 921 and decompress depth or color data that is read from memory or the L2 cache 921. Compression logic can be lossless compression logic that makes use of one or more of multiple compression algorithms. The type of compression that is performed by CODEC 927 can vary based on the statistical characteristics of the data to be compressed. For example, in some examples, delta color compression is performed on depth and color data on a per-tile basis. In some examples, CODEC 927 includes compression and decompression logic that can compress and decompress compute data associated with machine learning operations. CODEC 927 can, for example, compress sparse matrix data for sparse machine learning operations. CODEC 927 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

ROP 926 may be included within each processing cluster (e.g., cluster 914A-914N of FIG. 9A) instead of within the partition unit 920. In such an example, read and write requests for pixel data are transmitted over the memory crossbar 916 instead of pixel fragment data. The processed graphics data may be displayed on a display device, such as one of the one or more display device(s) 810A-810B of FIG. 8, routed for further processing by the processor(s) 802, or routed for further processing by one of the processing entities within the parallel processor 900 of FIG. 9A.

FIG. 9C is a block diagram of a processing cluster 914 within a parallel processing unit. For example, the processing cluster is an instance of one of the processing clusters 914A-914N of FIG. 9A. The processing cluster 914 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to follow divergent execution paths more readily through a given thread program. Persons skilled in the art will understand that a SIMD processing regime represents a functional subset of a SIMT processing regime.

Operation of the processing cluster 914 can be controlled via a pipeline manager 932 that distributes processing tasks to SIMT parallel processors. The pipeline manager 932 receives instructions from scheduler 910 of FIG. 9A and manages execution of those instructions via a graphics multiprocessor 934 and/or a texture unit 936. The illustrated graphics multiprocessor 934 is an exemplary instance of a SIMT parallel processor. However, various types of SIMT parallel processors of differing architectures may be included within the processing cluster 914. One or more instances of the graphics multiprocessor 934 can be included within a processing cluster 914. The graphics multiprocessor 934 can process data and a data crossbar 940 can be used to distribute the processed data to one of multiple possible destinations, including other shader units. The pipeline manager 932 can facilitate the distribution of processed data by specifying destinations for processed data to be distributed via the data crossbar 940.

Each graphics multiprocessor 934 within the processing cluster 914 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 914 constitute a thread. A set of threads executing across the set of parallel processing engines is a thread group. A thread group executes the same program on different input data. Each thread within a thread group can be assigned to a different processing engine within a graphics multiprocessor 934. A thread group may include fewer threads than the number of processing engines within the graphics multiprocessor 934. When a thread group includes fewer threads than the number of processing engines, one or more of the processing engines may be idle during cycles in which that thread group is being processed. A thread group may also include more threads than the number of processing engines within the graphics multiprocessor 934. When the thread group includes more threads than the number of processing engines within the graphics multiprocessor 934, processing can be performed over consecutive clock cycles. Optionally, multiple thread groups can be executed concurrently on graphics multiprocessor 934.

The graphics multiprocessor 934 may include an internal cache memory to perform load and store operations. Optionally, the graphics multiprocessor 934 can forego an internal cache and use a cache memory (e.g., level 1 (L1) cache 948) within the processing cluster 914. Each graphics multiprocessor 934 also has access to level 2 (L2) caches within the partition units (e.g., partition units 920A-920N of FIG. 9A) that are shared among all processing clusters 914 and may be used to transfer data between threads. The graphics multiprocessor 934 may also access off-chip global memory, which can include one or more of local parallel processor memory and/or system memory. Any memory external to the parallel processing unit 902 may be used as global memory. Embodiments in which the processing cluster 914 includes multiple instances of the graphics multiprocessor 934 can share common instructions and data, which may be stored in the L1 cache 948.

Each processing cluster 914 may include an MMU 945 (memory management unit) that is configured to map virtual addresses into physical addresses. In other examples, one or more instances of the MMU 945 may reside within the memory interface 918 of FIG. 9A. The MMU 945 includes a set of page table entries (PTEs) used to map a virtual address to a physical address of a tile and optionally a cache line index. The MMU 945 may include address translation lookaside buffers (TLB) or caches that may reside within the graphics multiprocessor 934 or the L1 cache 948 of processing cluster 914. The physical address is processed to distribute surface data access locality to allow efficient request interleaving among partition units. The cache line index may be used to determine whether a request for a cache line is a hit or miss.

In graphics and computing applications, a processing cluster 914 may be configured such that each graphics multiprocessor 934 is coupled to a texture unit 936 for performing texture mapping operations, e.g., determining texture sample positions, reading texture data, and filtering the texture data. Texture data is read from an internal texture L1 cache (not shown) or in some examples from the L1 cache within graphics multiprocessor 934 and is fetched from an L2 cache, local parallel processor memory, or system memory, as needed. Each graphics multiprocessor 934 outputs processed tasks to the data crossbar 940 to provide the processed task to another processing cluster 914 for further processing or to store the processed task in an L2 cache, local parallel processor memory, or system memory via the memory crossbar 916. A preROP 942 (pre-raster operations unit) is configured to receive data from graphics multiprocessor 934, direct data to ROP units, which may be located with partition units as described herein (e.g., partition units 920A-920N of FIG. 9A). The preROP 942 unit can perform optimizations for color blending, organize pixel color data, and perform address translations.

It will be appreciated that the core architecture described herein is illustrative and that variations and modifications are possible. Any number of processing units, e.g., graphics multiprocessor 934, texture units 936, preROPs 942, etc., may be included within a processing cluster 914. Further, while only one processing cluster 914 is shown, a parallel processing unit as described herein may include any number of instances of the processing cluster 914. Optionally, each processing cluster 914 can be configured to operate independently of other processing clusters 914 using separate and distinct processing units, L1 caches, L2 caches, etc.

FIG. 9D shows an example of graphics multiprocessor 934 in which the graphics multiprocessor 934 couples with the pipeline manager 932 of the processing cluster 914. The graphics multiprocessor 934 has an execution pipeline including but not limited to an instruction cache 952, an instruction unit 954, an address mapping unit 956, a register file 958, one or more general purpose graphics processing unit (GPGPU) cores 962, and one or more load/store units 966. The GPGPU cores 962 and load/store units 966 are coupled with cache memory 972 and shared memory 970 via a memory and cache interconnect 968. The graphics multiprocessor 934 may additionally include tensor and/or ray-tracing cores 963 that include hardware logic to accelerate matrix and/or ray-tracing operations.

The instruction cache 952 may receive a stream of instructions to execute from the pipeline manager 932. The instructions are cached in the instruction cache 952 and dispatched for execution by the instruction unit 954. The instruction unit 954 can dispatch instructions as thread groups (e.g., warps), with each thread of the thread group assigned to a different execution unit within GPGPU core 962. An instruction can access any of a local, shared, or global address space by specifying an address within a unified address space. The address mapping unit 956 can be used to translate addresses in the unified address space into a distinct memory address that can be accessed by the load/store units 966.

The register file 958 provides a set of registers for the functional units of the graphics multiprocessor 934. The register file 958 provides temporary storage for operands connected to the data paths of the functional units (e.g., GPGPU cores 962, load/store units 966) of the graphics multiprocessor 934. The register file 958 may be divided between each of the functional units such that each functional unit is allocated a dedicated portion of the register file 958. For example, the register file 958 may be divided between the different warps being executed by the graphics multiprocessor 934.

The GPGPU cores 962 can each include floating point units (FPUs) and/or integer arithmetic logic units (ALUs) that are used to execute instructions of the graphics multiprocessor 934. In some implementations, the GPGPU cores 962 can include hardware logic that may otherwise reside within the tensor and/or ray-tracing cores 963. The GPGPU cores 962 can be similar in architecture or can differ in architecture. For example and in some examples, a first portion of the GPGPU cores 962 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 934 can additionally include one or more fixed function or special function units to perform specific functions such as copy rectangle or pixel blending operations. One or more of the GPGPU cores can also include fixed or special function logic.

The GPGPU cores 962 may include SIMD logic capable of performing a single instruction on multiple sets of data. Optionally, GPGPU cores 962 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 968 is an interconnect network that connects each of the functional units of the graphics multiprocessor 934 to the register file 958 and to the shared memory 970. For example, the memory and cache interconnect 968 is a crossbar interconnect that allows the load/store unit 966 to implement load and store operations between the shared memory 970 and the register file 958. The register file 958 can operate at the same frequency as the GPGPU cores 962, thus data transfer between the GPGPU cores 962 and the register file 958 is very low latency. The shared memory 970 can be used to enable communication between threads that execute on the functional units within the graphics multiprocessor 934. The cache memory 972 can be used as a data cache for example, to cache texture data communicated between the functional units and the texture unit 936. The shared memory 970 can also be used as a program managed cached. The shared memory 970 and the cache memory 972 can couple with the data crossbar 940 to enable communication with other components of the processing cluster. Threads executing on the GPGPU cores 962 can programmatically store data within the shared memory in addition to the automatically cached data that is stored within the cache memory 972.

FIGS. 10A-10C illustrate additional graphics multiprocessors, according to examples. FIG. 10A-10B illustrate graphics multiprocessors 1025, 1050, which are related to the graphics multiprocessor 934 of FIG. 9C and may be used in place of one of those. Therefore, the disclosure of any features in combination with the graphics multiprocessor 934 herein also discloses a corresponding combination with the graphics multiprocessor(s) 1025, 1050, but is not limited to such. FIG. 10C illustrates a graphics processing unit (GPU) 1080 which includes dedicated sets of graphics processing resources arranged into multi-core groups 1065A-1065N, which correspond to the graphics multiprocessors 1025, 1050. The illustrated graphics multiprocessors 1025, 1050 and the multi-core groups 1065A-1065N can be streaming multiprocessors (SM) capable of simultaneous execution of a large number of execution threads.

The graphics multiprocessor 1025 of FIG. 10A includes multiple additional instances of execution resource units relative to the graphics multiprocessor 934 of FIG. 9D. For example, the graphics multiprocessor 1025 can include multiple instances of the instruction unit 1032A-1032B, register file 1034A-1034B, and texture unit(s) 1044A-1044B. The graphics multiprocessor 1025 also includes multiple sets of graphics or compute execution units (e.g., GPGPU core 1036A-1036B, tensor core 1037A-1037B, ray-tracing core 1038A-1038B) and multiple sets of load/store units 1040A-1040B. The execution resource units have a common instruction cache 1030, texture and/or data cache memory 1042, and shared memory 1046.

The various components can communicate via an interconnect fabric 1027. The interconnect fabric 1027 may include one or more crossbar switches to enable communication between the various components of the graphics multiprocessor 1025. The interconnect fabric 1027 may be a separate, high-speed network fabric layer upon which each component of the graphics multiprocessor 1025 is stacked. The components of the graphics multiprocessor 1025 communicate with remote components via the interconnect fabric 1027. For example, the cores 1036A-1036B, 1037A-1037B, and 1038A-1038B can each communicate with shared memory 1046 via the interconnect fabric 1027. The interconnect fabric 1027 can arbitrate communication within the graphics multiprocessor 1025 to ensure a fair bandwidth allocation between components.

The graphics multiprocessor 1050 of FIG. 10B includes multiple sets of execution resources 1056A-1056D, where each set of execution resource includes multiple instruction units, register files, GPGPU cores, and load store units, as illustrated in FIG. 9D and FIG. 10A. The execution resources 1056A-1056D can work in concert with texture unit(s) 1060A-1060D for texture operations, while sharing an instruction cache 1054, and shared memory 1053. For example, the execution resources 1056A-1056D can share an instruction cache 1054 and shared memory 1053, as well as multiple instances of a texture and/or data cache memory 1058A-1058B. The various components can communicate via an interconnect fabric 1052 similar to the interconnect fabric 1027 of FIG. 10A.

Persons skilled in the art will understand that the architecture described in FIGS. 1, 9A-9D, and 10A-10B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 902 of FIG. 9A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 10C illustrates a graphics processing unit (GPU) 1080 which includes dedicated sets of graphics processing resources arranged into multi-core groups 1065A-1065N. While the details of only a single multi-core group 1065A are provided, it will be appreciated that the other multi-core groups 1065B-1065N may be equipped with the same or similar sets of graphics processing resources. Details described with respect to the multi-core groups 1065A-1065N may also apply to any graphics multiprocessor 934, 1025, 1050 described herein.

As illustrated, a multi-core group 1065A may include a set of graphics cores 1070, a set of tensor cores 1071, and a set of ray tracing cores 1072. A scheduler/dispatcher 1068 schedules and dispatches the graphics threads for execution on the various cores 1070, 1071, 1072. A set of register files 1069 store operand values used by the cores 1070, 1071, 1072 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1073 store graphics data such as texture data, vertex data, pixel data, ray data, bounding volume data, etc., locally within each multi-core group 1065A. One or more texture units 1074 can also be used to perform texturing operations, such as texture mapping and sampling. A Level 2 (L2) cache 1075 shared by all or a subset of the multi-core groups 1065A-1065N stores graphics data and/or instructions for multiple concurrent graphics threads. As illustrated, the L2 cache 1075 may be shared across a plurality of multi-core groups 1065A-1065N. One or more memory controllers 1067 couple the GPU 1080 to a memory 1066 which may be a system memory (e.g., DRAM) and/or a dedicated graphics memory (e.g., GDDR6 memory).

Input/output (I/O) circuitry 1063 couples the GPU 1080 to one or more I/O devices 1062 such as digital signal processors (DSPs), network controllers, or user input devices. An on-chip interconnect may be used to couple the I/O devices 1062 to the GPU 1080 and memory 1066. One or more I/O memory management units (IOMMUs) 1064 of the I/O circuitry 1063 couple the I/O devices 1062 directly to the system memory 1066. Optionally, the IOMMU 1064 manages multiple sets of page tables to map virtual addresses to physical addresses in system memory 1066. The I/O devices 1062, CPU(s) 1061, and GPU(s) 1080 may then share the same virtual address space.

In one implementation of the IOMMU 1064, the IOMMU 1064 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1066). The base addresses of each of the first and second sets of page tables may be stored in control registers and swapped out on a context switch (e.g., so that the new context is provided with access to the relevant set of page tables). While not illustrated in FIG. 10C, each of the cores 1070, 1071, 1072 and/or multi-core groups 1065A-1065N may include translation lookaside buffers (TLBs) to cache guest virtual to guest physical translations, guest physical to host physical translations, and guest virtual to host physical translations.

The CPU(s) 1061, GPUs 1080, and I/O devices 1062 may be integrated on a single semiconductor chip and/or chip package. The illustrated memory 1066 may be integrated on the same chip or may be coupled to the memory controllers 1067 via an off-chip interface. In one implementation, the memory 1066 comprises GDDR6 memory which shares the same virtual address space as other physical system-level memories, although the underlying principles described herein are not limited to this specific implementation.

The tensor cores 1071 may include a plurality of execution units specifically designed to perform matrix operations, which are the fundamental compute operations used to perform deep learning operations. For example, simultaneous matrix multiplication operations may be used for neural network training and inferencing. The tensor cores 1071 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1071. The training of neural networks, in particular, requires a significant number of matrix dot product operations. In order to process an inner-product formulation of an N×N×N matrix multiply, the tensor cores 1071 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1071 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1071 support a sparse mode of operation for matrices in which the vast majority of values are zero. The tensor cores 1071 include support for sparse input matrices that are encoded in a sparse matrix representation (e.g., coordinate list encoding (COO), compressed sparse row (CSR), compress sparse column (CSC), etc.). The tensor cores 1071 also include support for compressed sparse matrix representations in the event that the sparse matrix representation may be further compressed. Compressed, encoded, and/or compressed and encoded matrix data, along with associated compression and/or encoding metadata, can be read by the tensor cores 1071 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1071, output matrix C may be output in a compressed format, a sparse encoding, or a compressed sparse encoding.

The ray tracing cores 1072 may accelerate ray tracing operations for both real-time ray tracing and non-real-time ray tracing implementations. In particular, the ray tracing cores 1072 may include ray traversal/intersection circuitry for performing ray traversal using bounding volume hierarchies (BVHs) and identifying intersections between rays and primitives enclosed within the BVH volumes. The ray tracing cores 1072 may also include circuitry for performing depth testing and culling (e.g., using a Z buffer or similar arrangement). In one implementation, the ray tracing cores 1072 perform traversal and intersection operations in concert with the image denoising techniques described herein, at least a portion of which may be executed on the tensor cores 1071. For example, the tensor cores 1071 may implement a deep learning neural network to perform denoising of frames generated by the ray tracing cores 1072. However, the CPU(s) 1061, graphics cores 1070, and/or ray tracing cores 1072 may also implement all or a portion of the denoising and/or deep learning algorithms.

In addition, as described above, a distributed approach to denoising may be employed in which the GPU 1080 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1072 may process all BVH traversal and/or ray-primitive intersections, saving the graphics cores 1070 from being overloaded with thousands of instructions per ray. For example, each ray tracing core 1072 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1065A can simply launch a ray probe, and the ray tracing cores 1072 independently perform ray traversal and intersection and return hit data (e.g., a hit, no hit, multiple hits, etc.) to the thread context. The other cores 1070, 1071 are freed to perform other graphics or compute work while the ray tracing cores 1072 perform the traversal and intersection operations.

Optionally, each ray tracing core 1072 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1070 and tensor cores 1071) are freed to perform other forms of graphics work.

In some examples described below, a hybrid rasterization/ray tracing approach is used in which work is distributed between the graphics cores 1070 and ray tracing cores 1072.

The ray tracing cores 1072 (and/or other cores 1070, 1071) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1072, graphics cores 1070 and tensor cores 1071 is Vulkan API (e.g., Vulkan version 1.1.85 and later). Note, however, that the underlying principles described herein are not limited to any particular ray tracing ISA.

In general, the various cores 1072, 1071, 1070 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1072 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1072 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1072 can also be used to perform computations that are not directly analogous to ray tracing. For example, mesh projection, mesh refinement, and volume sampling computations can be accelerated using the ray tracing cores 1072. Generic coordinate space calculations, such as nearest neighbor calculations can also be performed. For example, the set of points near a given point can be discovered by defining a bounding box in the coordinate space around the point. BVH and ray probe logic within the ray tracing cores 1072 can then be used to determine the set of point intersections within the bounding box. The intersections constitute the origin point and the nearest neighbors to that origin point. Computations that are performed using the ray tracing cores 1072 can be performed in parallel with computations performed on the graphics cores 1072 and tensor cores 1071. A shader compiler can be configured to compile a compute shader or other general-purpose graphics processing program into low level primitives that can be parallelized across the graphics cores 1070, tensor cores 1071, and ray tracing cores 1072.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

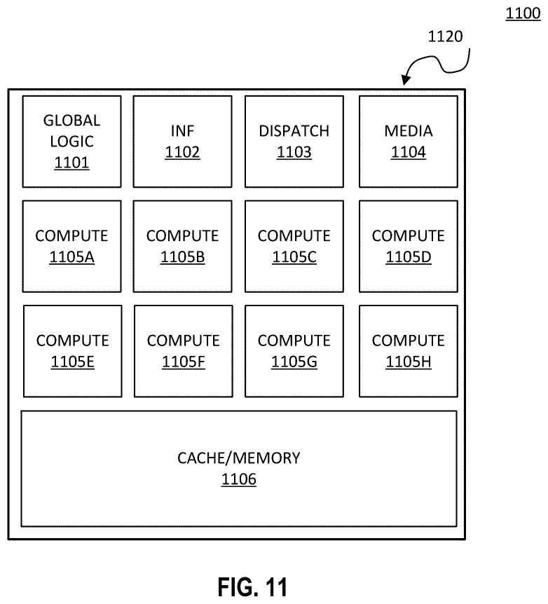

FIG. 11 shows a parallel computing system 1100, according to some examples. In some examples the parallel computing system 1100 includes a parallel processor 1120, which can be a graphics processor or compute accelerator as described herein. The parallel processor 1120 includes a global logic unit 1101, an interface 1102, a thread dispatcher 1103, a media unit 1104, a set of compute units 1105A-1105H, and a cache/memory units 1106. The global logic unit 1101, in some examples, includes global functionality for the parallel processor 1120, including device configuration registers, global schedulers, power management logic, and the like. The interface 1102 can include a front-end interface for the parallel processor 1120. The thread dispatcher 1103 can receive workloads from interface 1102 and dispatch threads for the workload to the compute units 1105A-1105H. If the workload includes any media operations, at least a portion of those operations can be performed by the media unit 1104. The media unit can also offload some operations to the compute units 1105A-1105H. The cache/memory units 1106 can include cache memory (e.g., L3 cache) and local memory (e.g., HBM, GDDR) for the parallel processor 1120.

### Example Core Architectures—In-Order and Out-of-Order Core Block Diagram

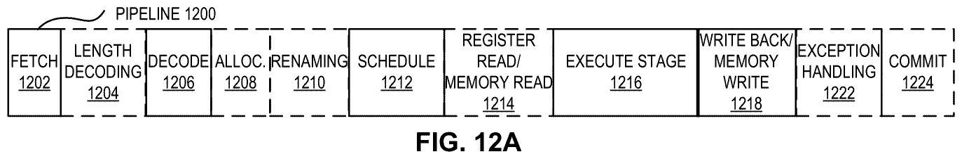

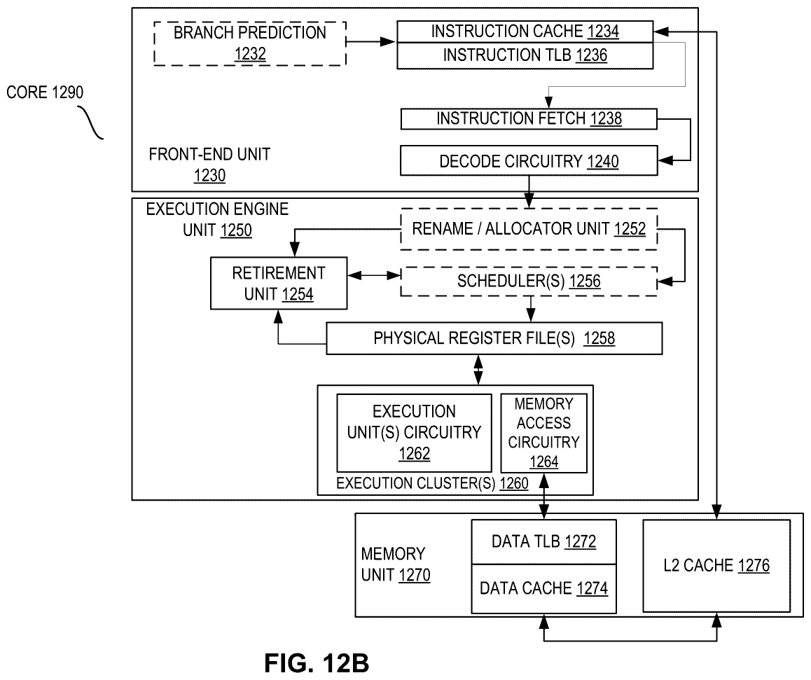

FIG. 12A is a block diagram illustrating both an example in-order pipeline and an example register renaming, out-of-order issue/execution pipeline according to examples. FIG. 12B is a block diagram illustrating both an example in-order architecture core and an example register renaming, out-of-order issue/execution architecture core to be included in a processor according to examples. The solid lined boxes in FIGS. 12A-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12A, a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1206 and the register read/memory read stage 1214 may be combined into one pipeline stage. In some examples, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12B may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12B shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In some examples, the instruction cache circuitry 1234 is included in the memory unit circuitry 1270 rather than the front-end circuitry 1230. The decode circuitry 1240 (or decoder) may decode instructions, and generate as an output one or more micro-operations, microcode entry points, microinstructions, other instructions, or other control signals, which are decoded from, or which otherwise reflect, or are derived from, the original instructions. The decode circuitry 1240 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1240 may be implemented using various different mechanisms. Examples of suitable mechanisms include, but are not limited to, look-up tables, hardware implementations, programmable logic arrays (PLAs), microcode read only memories (ROMs), etc. In some examples, the core 1290 includes a microcode ROM (not shown) or other medium that stores microcode for certain macroinstructions (e.g., in decode circuitry 1240 or otherwise within the front-end circuitry 1230). In some examples, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine circuitry 1250.

The execution engine circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In some examples, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270. In some examples, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 1290 includes logic to support a packed data instruction set architecture extension (e.g., AVX1, AVX2), thereby allowing the operations used by many multimedia applications to be performed using packed data.

### Example Execution Unit(s) Circuitry

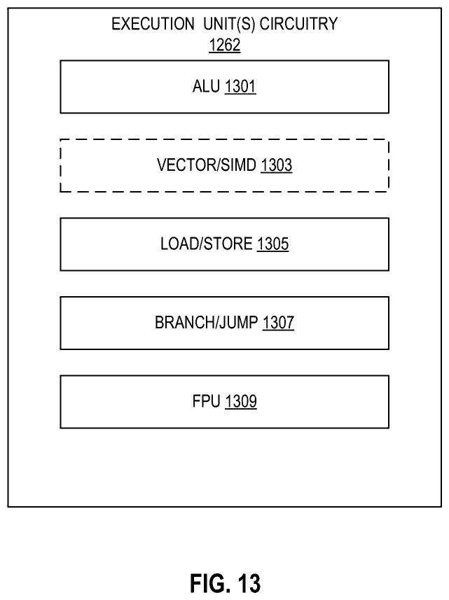

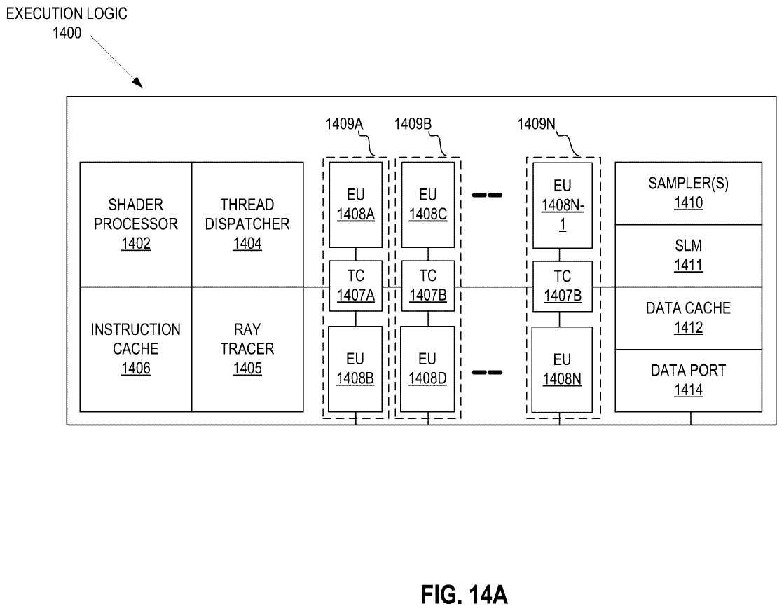

FIG. 13 illustrates examples of execution unit(s) circuitry, such as execution unit(s) circuitry 1262 of FIG. 12B. As illustrated, execution unit(s) circuitry BPH62 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers). Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Graphics Execution Units

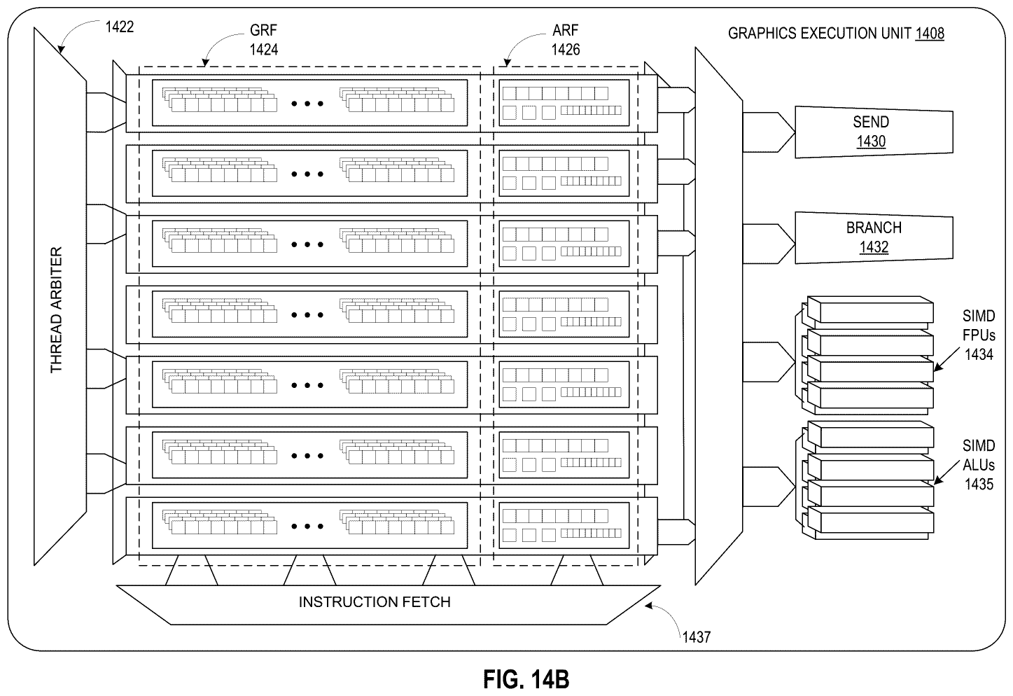

FIGS. 14A-14B illustrate thread execution logic 1400 including an array of processing elements employed in a graphics processor core according to examples described herein. Elements of FIGS. 14A-14B having the same reference numbers (or names) as the elements of any other figure herein can operate or function in any manner similar to that described elsewhere herein, but are not limited to such. FIG. 14A is representative of an execution unit within a general-purpose graphics processor, while FIG. 14B is representative of an execution unit that may be used within a compute accelerator.

As illustrated in FIG. 14A, in some examples thread execution logic 1400 includes a shader processor 1402, a thread dispatcher 1404, instruction cache 1406, a scalable execution unit array including a plurality of execution units 1408A-1408N, a sampler 1410, shared local memory 1411, a data cache 1412, and a data port 1414. In some examples the scalable execution unit array can dynamically scale by enabling or disabling one or more execution units (e.g., any of execution units 1408A, 1408B, 1408C, 1408D, through 1408N-1 and 1408N) based on the computational requirements of a workload. In some examples the included components are interconnected via an interconnect fabric that links to each of the components. In some examples, thread execution logic 1400 includes one or more connections to memory, such as system memory or cache memory, through one or more of instruction cache 1406, data port 1414, sampler 1410, and execution units 1408A-1408N. In some examples, each execution unit (e.g. 1408A) is a stand-alone programmable general-purpose computational unit that is capable of executing multiple simultaneous hardware threads while processing multiple data elements in parallel for each thread. In various examples, the array of execution units 1408A-1408N is scalable to include any number individual execution units.

In some examples, the execution units 1408A-1408N are primarily used to execute shader programs. A shader processor 1402 can process the various shader programs and dispatch execution threads associated with the shader programs via a thread dispatcher 1404. In some examples the thread dispatcher includes logic to arbitrate thread initiation requests from the graphics and media pipelines and instantiate the requested threads on one or more execution unit in the execution units 1408A-1408N. For example, a geometry pipeline can dispatch vertex, tessellation, or geometry shaders to the thread execution logic for processing. In some examples, thread dispatcher 1404 can also process runtime thread spawning requests from the executing shader programs.

In some examples, the execution units 1408A-1408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1408A-1408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1408A-1408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1408A-1408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1408A-1408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 1409A-1409N having thread control logic (1407A-1407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1409A-1409N includes at least two execution units. For example, fused execution unit 1409A includes a first EU 1408A, second EU 1408B, and thread control logic 1407A that is common to the first EU 1408A and the second EU 1408B. The thread control logic 1407A controls threads executed on the fused graphics execution unit 1409A, allowing each EU within the fused execution units 1409A-1409N to execute using a common instruction pointer register.

One or more internal instruction caches (e.g., 1406) are included in the thread execution logic 1400 to cache thread instructions for the execution units. In some examples, one or more data caches (e.g., 1412) are included to cache thread data during thread execution. Threads executing on the execution logic 1400 can also store explicitly managed data in the shared local memory 1411. In some examples, a sampler 1410 is included to provide texture sampling for 3D operations and media sampling for media operations. In some examples, sampler 1410 includes specialized texture or media sampling functionality to process texture or media data during the sampling process before providing the sampled data to an execution unit.

During execution, the graphics and media pipelines send thread initiation requests to thread execution logic 1400 via thread spawning and dispatch logic. Once a group of geometric objects has been processed and rasterized into pixel data, pixel processor logic (e.g., pixel shader logic, fragment shader logic, etc.) within the shader processor 1402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1402 then executes an application programming interface (API)-supplied pixel or fragment shader program. To execute the shader program, the shader processor 1402 dispatches threads to an execution unit (e.g., 1408A) via thread dispatcher 1404. In some examples, shader processor 1402 uses texture sampling logic in the sampler 1410 to access texture data in texture maps stored in memory. Arithmetic operations on the texture data and the input geometry data compute pixel color data for each geometric fragment, or discards one or more pixels from further processing.

In some examples, the data port 1414 provides a memory access mechanism for the thread execution logic 1400 to output processed data to memory for further processing on a graphics processor output pipeline. In some examples, the data port 1414 includes or couples to one or more cache memories (e.g., data cache 1412) to cache data for memory access via the data port.

In some examples, the execution logic 1400 can also include a ray tracer 1405 that can provide ray tracing acceleration functionality. The ray tracer 1405 can support a ray tracing instruction set that includes instructions/functions for ray generation.

FIG. 14B illustrates exemplary internal details of an execution unit 1408, according to examples. A graphics execution unit 1408 can include an instruction fetch unit 1437, a general register file array (GRF) 1424, an architectural register file array (ARF) 1426, a thread arbiter 1422, a send unit 1430, a branch unit 1432, a set of SIMD floating point units (FPUs) 1434, and in some examples a set of dedicated integer SIMD ALUs 1435. The GRF 1424 and ARF 1426 includes the set of general register files and architecture register files associated with each simultaneous hardware thread that may be active in the graphics execution unit 1408. In some examples, per thread architectural state is maintained in the ARF 1426, while data used during thread execution is stored in the GRF 1424. The execution state of each thread, including the instruction pointers for each thread, can be held in thread-specific registers in the ARF 1426.

In some examples the graphics execution unit 1408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1408 is not limited to the number of hardware threads, and multiple logical threads can be assigned to each hardware thread.

In some examples, the graphics execution unit 1408 can co-issue multiple instructions, which may each be different instructions. The thread arbiter 1422 of the graphics execution unit thread 1408 can dispatch the instructions to one of the send unit 1430, branch unit 1432, or SIMD FPU(s) 1434 for execution. Each execution thread can access 128 general-purpose registers within the GRF 1424, where each register can store 32 bytes, accessible as a SIMD 8-element vector of 32-bit data elements. In some examples, each execution unit thread has access to 4 Kbytes within the GRF 1424, although examples are not so limited, and greater or fewer register resources may be provided in other examples. In some examples the graphics execution unit 1408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1424 can store a total of 28 Kbytes. Where 16 threads may access 4Kbytes, the GRF 1424 can store a total of 64Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1430. In some examples, branch instructions are dispatched to a dedicated branch unit 1432 to facilitate SIMD divergence and eventual convergence.

In some examples the graphics execution unit 1408 includes one or more SIMD floating point units (FPU(s)) 1434 to perform floating-point operations. In some examples, the FPU(s) 1434 also support integer computation. In some examples the FPU(s) 1434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1435 are also present, and may be specifically optimized to perform operations associated with machine learning computations.

In some examples, arrays of multiple instances of the graphics execution unit 1408 can be instantiated in a graphics sub-core grouping (e.g., a sub-slice). For scalability, product architects can choose the exact number of execution units per sub-core grouping. In some examples the execution unit 1408 can execute instructions across a plurality of execution channels. In a further example, each thread executed on the graphics execution unit 1408 is executed on a different channel.

### Graphics Pipeline

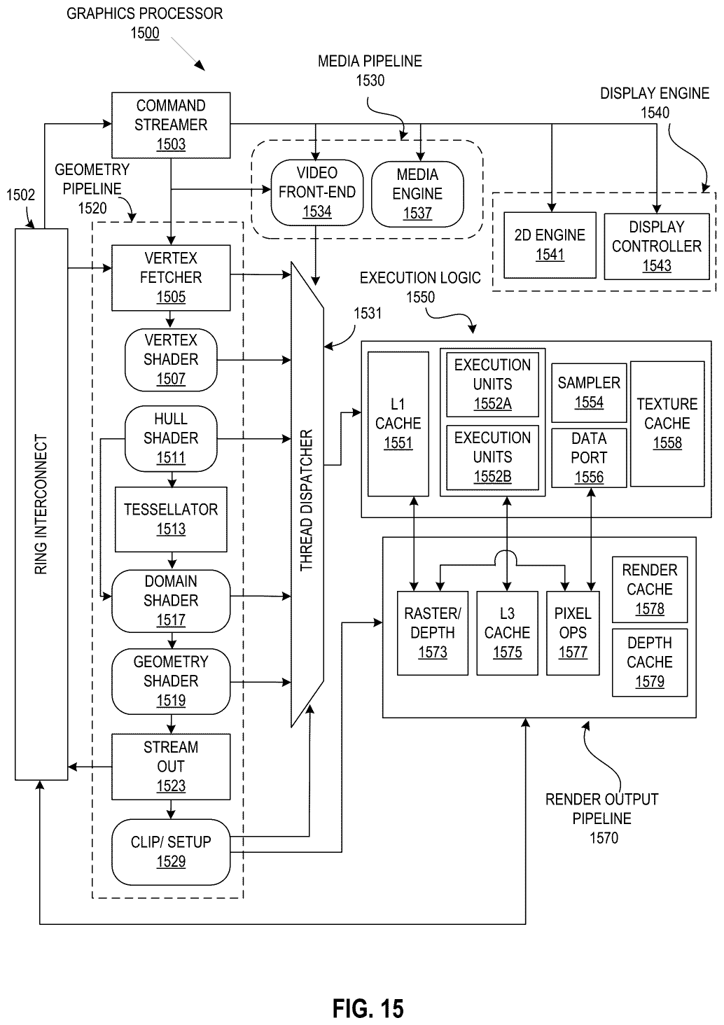

FIG. 15 is a block diagram of another example of a graphics processor 1500. Elements of FIG. 15 having the same reference numbers (or names) as the elements of any other figure herein can operate or function in any manner similar to that described elsewhere herein, but are not limited to such.

In some examples, graphics processor 1500 includes a geometry pipeline 1520, a media pipeline 1530, a display engine 1540, thread execution logic 1550, and a render output pipeline 1570. In some examples, graphics processor 1500 is a graphics processor within a multi-core processing system that includes one or more general-purpose processing cores. The graphics processor is controlled by register writes to one or more control registers (not shown) or via commands issued to graphics processor 1500 via a ring interconnect 1502. In some examples, ring interconnect 1502 couples graphics processor 1500 to other processing components, such as other graphics processors or general-purpose processors. Commands from ring interconnect 1502 are interpreted by a command streamer 1503, which supplies instructions to individual components of the geometry pipeline 1520 or the media pipeline 1530.

In some examples, command streamer 1503 directs the operation of a vertex fetcher 1505 that reads vertex data from memory and executes vertex-processing commands provided by command streamer 1503. In some examples, vertex fetcher 1505 provides vertex data to a vertex shader 1507, which performs coordinate space transformation and lighting operations to each vertex. In some examples, vertex fetcher 1505 and vertex shader 1507 execute vertex-processing instructions by dispatching execution threads to execution units 1552A-1552B via a thread dispatcher 1531.

In some examples, execution units 1552A-1552B are an array of vector processors having an instruction set for performing graphics and media operations. In some examples, execution units 1552A-1552B have an attached L1 cache 1551 that is specific for each array or shared between the arrays. The cache can be configured as a data cache, an instruction cache, or a single cache that is partitioned to contain data and instructions in different partitions.

In some examples, geometry pipeline 1520 includes tessellation components to perform hardware-accelerated tessellation of 3D objects. In some examples, a programmable hull shader 1511 configures the tessellation operations. A programmable domain shader 1517 provides back-end evaluation of tessellation output. A tessellator 1513 operates at the direction of hull shader 1511 and contains special purpose logic to generate a set of detailed geometric objects based on a coarse geometric model that is provided as input to geometry pipeline 1520. In some examples, if tessellation is not used, tessellation components (e.g., hull shader 1511, tessellator 1513, and domain shader 1517) can be bypassed.

In some examples, complete geometric objects can be processed by a geometry shader 1519 via one or more threads dispatched to execution units 1552A-1552B, or can proceed directly to the clipper 1529. In some examples, the geometry shader operates on entire geometric objects, rather than vertices or patches of vertices as in previous stages of the graphics pipeline. If the tessellation is disabled the geometry shader 1519 receives input from the vertex shader 1507. In some examples, geometry shader 1519 is programmable by a geometry shader program to perform geometry tessellation if the tessellation units are disabled.

Before rasterization, a clipper 1529 processes vertex data. The clipper 1529 may be a fixed function clipper or a programmable clipper having clipping and geometry shader functions. In some examples, a rasterizer and depth test component 1573 in the render output pipeline 1570 dispatches pixel shaders to convert the geometric objects into per pixel representations. In some examples, pixel shader logic is included in thread execution logic 1550. In some examples, an application can bypass the rasterizer and depth test component 1573 and access un-rasterized vertex data via a stream out unit 1523.

The graphics processor 1500 has an interconnect bus, interconnect fabric, or some other interconnect mechanism that allows data and message passing amongst the major components of the processor. In some examples, execution units 1552A-1552B and associated logic units (e.g., L1 cache 1551, sampler 1554, texture cache 1558, etc.) interconnect via a data port 1556 to perform memory access and communicate with render output pipeline components of the processor. In some examples, sampler 1554, caches 1551, 1558 and execution units 1552A-1552B each have separate memory access paths. In some examples the texture cache 1558 can also be configured as a sampler cache.

In some examples, render output pipeline 1570 contains a rasterizer and depth test component 1573 that converts vertex-based objects into an associated pixel-based representation. In some examples, the rasterizer logic includes a windower/masker unit to perform fixed function triangle and line rasterization. An associated render cache 1578 and depth cache 1579 are also available in some examples. A pixel operations component 1577 performs pixel-based operations on the data, though in some instances, pixel operations associated with 2D operations (e.g., bit block image transfers with blending) are performed by the 2D engine 1541, or substituted at display time by the display controller 1543 using overlay display planes. In some examples, a shared L3 cache 1575 is available to all graphics components, allowing the sharing of data without the use of main system memory.

In some examples, graphics processor media pipeline 1530 includes a media engine 1537 and a video front-end 1534. In some examples, video front-end 1534 receives pipeline commands from the command streamer 1503. In some examples, media pipeline 1530 includes a separate command streamer. In some examples, video front-end 1534 processes media commands before sending the command to the media engine 1537. In some examples, media engine 1537 includes thread spawning functionality to spawn threads for dispatch to thread execution logic 1550 via thread dispatcher 1531.

In some examples, graphics processor 1500 includes a display engine 1540. In some examples, display engine 1540 is external to processor 1500 and couples with the graphics processor via the ring interconnect 1502, or some other interconnect bus or fabric. In some examples, display engine 1540 includes a 2D engine 1541 and a display controller 1543. In some examples, display engine 1540 contains special purpose logic capable of operating independently of the 3D pipeline. In some examples, display controller 1543 couples with a display device (not shown), which may be a system integrated display device, as in a laptop computer, or an external display device attached via a display device connector.

In some examples, the geometry pipeline 1520 and media pipeline 1530 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Further Examples

Example 1 provides an exemplary method comprising: receiving a first request to process data for a first application by a first accelerator of a plurality of accelerators of a computing system; scheduling resources for the first request based on the first request and a second request to process data for a second application by a second accelerator of the plurality of accelerators, the first and second requests having one or more priority indications indicating priority between the first and second requests; and processing the data for the first application using the resources as scheduled responsive to the first request.

Example 2 includes the substance of Example 1, wherein the first request comprises a descriptor identifying the first application, an operation to be performed on the data by the first accelerator, and source and destination of the data for the first application, and wherein the first application is mapped to a priority of the first application.

Example 3 includes the substance of Examples 1 to 2, wherein a first data structure is maintained to track mapping between applications and respective application priorities, an entry in the first data structure indicating the first application and the priority of the first application.

Example 4 includes the substance of Examples 1 to 3, wherein scheduling the resources for the first request comprises selecting a group of applications to assign the first request from a plurality of groups of applications with respective application priorities, the group of applications mapping to the priority.

Example 5 includes the substance of Examples 1 to 4, wherein processing the data for the first application using the resources comprises exhausting requests within the group of applications prior to processing data for one or more requests within another group of applications that have a lower priority.

Example 6 includes the substance of Examples 1 to 5, wherein processing the data for the first application using the resources comprises processing requests of the plurality of groups on a weighted round-robin basis, where requests from the group of applications are favored with a larger weight over requests from another group of applications that have a lower priority.

Example 7 includes the substance of Examples 1 to 6, wherein the descriptor further includes a field indicating a priority to use the accelerator by the first request.

Example 8 includes the substance of Examples 1 to 7, wherein a second data structure is maintained to track mapping between accelerators and priorities to use the respective accelerators, an entry in the second data structure for the first application indicating the first accelerator and the priority to use the first accelerator.

Example 9 includes the substance of Examples 1 to 8, wherein processing the data using the resources comprises prioritizing the first request for the first application through the first accelerator over another request with a lower priority to use the first accelerator based comparing priority indications of the request and the another request in the field.

Example 10 includes the substance of Examples 1 to 9, wherein the one or more priority indications include a first indication to specify a first priority for the first application and a second indication to specify a second priority to use the first accelerator by the first request; wherein the first indication is used to select a group of applications to assign the request from a plurality of groups of applications with respective application priorities, the group mapped to the first priority; and wherein the second indication is used to prioritize the first request and another request within the group of applications to use the first accelerator.

Example 11 includes the substance of Examples 1 to 10, wherein scheduling the resources for the first request based on the one or more priority indications corresponding to the first request is performed by a circuitry within an accelerator complex.

Example 12 provides a computing system comprising: a processor and an accelerator system including a plurality of accelerators coupled to the processor to receive a first request to process data for a first application by a first accelerator of the plurality of accelerators, an accelerator of the plurality of accelerators being dedicated to one or more specialized computations of the computing system for data processing, the accelerator system to schedule resources for the first request based on the first request and a second request to process data for a second application by a second accelerator of the plurality of accelerators, the first and second requests having one or more priority indications indicating priority between the first and second requests, and the accelerator system to process the data for the first application using the resources as scheduled responsive to the first request.

Example 13 includes the substance of Example 12, wherein the first request comprises a descriptor identifying the first application, an operation to be performed on the data for the first application by the first accelerator, and source and destination of the data, and wherein the first application is mapped to a priority of the first application.

Example 14 includes the substance of Examples 12 to 13, wherein a first data structure is maintained to track mapping between applications and respective application priorities, an entry in the first data structure indicating the first application and the priority of the first application.

Example 15 includes the substance of Examples 12 to 14, wherein the descriptor further includes a field indicating a priority to use the first accelerator by the first request.

Example 16 includes the substance of Examples 12 to 15, wherein a second data structure is maintained to track mapping between accelerators and priorities to use the respective accelerators, an entry in the second data structure for the first application indicating the first accelerator and the priority to use the first accelerator.

Example 17 includes the substance of Examples 12 to 16, wherein the one or more priority indications includes a first indication to specify a first priority for the application and a second indication to specify a second priority to use the accelerator by the request; wherein the first indication is used to select a group of applications to assign the request from a plurality of groups of applications with respective application priorities, the group mapped to the first priority; and wherein the second indication is used to prioritize the request and another request within the group of applications.

Example 18 provides an exemplary machine-readable storage medium storing instructions that when executed by a machine, are capable of performance of: receiving a first request to process data for a first application by a first accelerator of a plurality of accelerators of a computing system; scheduling resources for the first request based on the first request and a second request to process data for a second application by a second accelerator of the plurality of accelerators, the first and second requests having one or more priority indications indicating priority between the first and second requests; and processing the data for the first application using the resources as scheduled responsive to the first request.

Example 19 includes the substance of Example 18, wherein the first request comprises a descriptor identifying the first application, an operation to be performed on the data for the first application by the first accelerator, and source and destination of the data, and wherein the first application is mapped to a priority of the first application.

Example 20 includes the substance of Examples 18 to 19, wherein scheduling the resources for the first request based on the one or more priority indications corresponding to the first request is performed by a circuitry within an accelerator complex.

### Additional Explanation

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method comprising:
receiving a first request to process data for a first application by a first accelerator of a plurality of accelerators of a computing system, an accelerator of the plurality of accelerators being dedicated to one or more respective specialized computations of the computing system for data processing;
scheduling resources for the first request based on the first request and a second request to process data for a second application by a second accelerator of the plurality of accelerators, the first and second requests having one or more priority indications indicating priority between the first and second requests; and
processing the data for the first application using the resources as scheduled responsive to the first request.

2. The method of claim 1, wherein the first request comprises a descriptor identifying the first application, an operation to be performed on the data by the first accelerator, and source and destination of the data for the first application, and wherein the first application is mapped to a priority of the first application.

3. The method of claim 2, wherein a first data structure is maintained to track mapping between applications and respective application priorities, an entry in the first data structure indicating the first application and the priority of the first application.

4. The method of claim 2, wherein scheduling the resources for the first request comprises selecting a group of applications to assign the first request from a plurality of groups of applications with respective application priorities, the group of applications mapping to the priority.

5. The method of claim 4, wherein processing the data for the first application using the resources comprises exhausting requests within the group of applications prior to processing data for one or more requests within another group of applications that have a lower priority.

6. The method of claim 4, wherein processing the data for the first application using the resources comprises processing requests of the plurality of groups on a weighted round-robin basis, where requests from the group of applications are favored with a larger weight over requests from another group of applications that have a lower priority.

7. The method of claim 2, wherein the descriptor further includes a field indicating a priority to use the accelerator by the first request.

8. The method of claim 7, wherein a second data structure is maintained to track mapping between accelerators and priorities to use the respective accelerators, an entry in the second data structure for the first application indicating the first accelerator and the priority to use the first accelerator.

9. The method of claim 7, wherein processing the data for the first application using the resources comprises prioritizing the first request for the first application through the first accelerator over another request with a lower priority to use the first accelerator based comparing priority indications of the request and the another request in the field.

10. The method of claim 1, wherein the one or more priority indications include a first indication to specify a first priority for the first application and a second indication to specify a second priority to use the first accelerator by the first request; wherein the first indication is used to select a group of applications to assign the request from a plurality of groups of applications with respective application priorities, the group mapped to the first priority; and wherein the second indication is used to prioritize the first request and another request within the group of applications to use the first accelerator.

11. The method of claim 1, wherein scheduling the resources for the first request based on the one or more priority indications corresponding to the first request is performed by a circuitry within an accelerator complex.

12. A computing system comprising:
a processor; and
an accelerator system including a plurality of accelerators coupled to the processor to receive a first request to process data for a first application by a first accelerator of the plurality of accelerators, an accelerator of the plurality of accelerators being dedicated to one or more specialized computations of the computing system for data processing,
the accelerator system to schedule resources for the first request based on the first request and a second request to process data for a second application by a second accelerator of the plurality of accelerators, the first and second requests having one or more priority indications indicating priority between the first and second requests, and
the accelerator system to process the data for the first application using the resources as scheduled responsive to the first request.

13. The computing system of claim 12, wherein the first request comprises a descriptor identifying the first application, an operation to be performed on the data for the first application by the first accelerator, and source and destination of the data, and wherein the first application is mapped to a priority of the first application.

14. The computing system of claim 13, wherein a first data structure is maintained to track mapping between applications and respective application priorities, an entry in the first data structure indicating the first application and the priority of the first application.

15. The computing system of claim 13, wherein the descriptor further includes a field indicating a priority to use the first accelerator by the first request.

16. The computing system of claim 15, wherein a second data structure is maintained to track mapping between accelerators and priorities to use the respective accelerators, an entry in the second data structure for the first application indicating the first accelerator and the priority to use the first accelerator.

17. The computing system of claim 12, wherein the one or more priority indications includes a first indication to specify a first priority for the first application and a second indication to specify a second priority to use the first accelerator by the first request; wherein the first indication is used to select a group of applications to assign the request from a plurality of groups of applications with respective application priorities, the group mapped to the first priority; and wherein the second indication is used to prioritize the first request and another request within the group of applications to use the first accelerator.

18. A non-transitory machine-readable storage medium storing instructions that when executed by a machine, are capable of causing performance of:
receiving a first request to process data for a first application by a first accelerator of a plurality of accelerators of a computing system, an accelerator of the plurality of accelerators being dedicated to one or more respective specialized computations of the computing system for data processing;
scheduling resources for the first request based on the first request and a second request to process data for a second application by a second accelerator of the plurality of accelerators, the first and second requests having one or more priority indications indicating priority between the first and second requests; and
processing the data for the first application using the resources as scheduled responsive to the first request.

19. The non-transitory machine-readable storage medium of claim 18, wherein the first request comprises a descriptor identifying the first application, an operation to be performed on the data for the first application by the first accelerator, and source and destination of the data, and wherein the first application is mapped to a priority of the first application.

20. The non-transitory machine-readable storage medium of claim 18, wherein scheduling the resources for the first request based on the one or more priority indications corresponding to the first request is performed by a circuitry within an accelerator complex.
